(19) United States
(12) Patent Application Publication
(10) Pub. No.: US 2025/0156791 A1
(43) Pub. Date: May 15, 2025

(54) Service-Based Network Data Request Choreography for Program Qualification Analysis

(71) Applicant: Synchrony Bank, Stamford, CT (US)

(72) Inventors: David Chau, Stamford, CT (US); Syed Kamran, Stamford, CT (US); Xuhui Li, Stamford, CT (US); Stephen Butler, Stamford, CT (US); Venkataramakrishna Narukulla, Stamford, CT (US); Richard Carrasco, Stamford, CT (US); Eswar Mamidi, Stamford, CT (US); Deepthi Potluri, Stamford, CT (US); Courtney Pitts, Stamford, CT (US); Nitin Kumar Vinod, Stamford, CT (US); Paul Aughey, Stamford, CT (US); Taylor Austin, Stamford, CT (US)

(73) Assignee: Synchrony Bank, Stamford, CT (US)

(21) Appl. No.: 19/022,220

(22) Filed: Jan. 15, 2025

Related U.S. Application Data
(62) Division of application No. 18/154,293, filed on Jan. 13, 2023.
Application No. 18/154,293 is a continuation-in-part of application No. 17/230,656, filed on Apr. 14, 2021, now abandoned.
(60) Provisional application No. 63/009,545, filed on Apr. 14, 2020.

(51) Int. Cl. G06Q 10/0639; G06Q 40/03

(52) U.S. Cl. CPC G06Q 10/06393; G06Q 40/03

(57) ABSTRACT

A system determines an amount of time available for responding to a request regarding eligibility for a client account for a modification based on a confidence grade for the client. The system transmits a first query and a second query. The system uses trained machine learning model(s) to determine respective estimated receipt times of first and second datasets responsive to the first and second queries, and to determine respective importance levels of the first and second datasets to determining the confidence grade. The system generates a preliminary confidence grade based on the first dataset, and delays generation of the confidence grade until the second dataset is received based on the estimated receipt times and importance levels. The system updates the preliminary confidence grade using the second dataset to generate the confidence grade, determines the eligibility determination, and updates the training of the machine learning models.

### CROSS-REFERENCE TO RELATED APPLICATIONS

The present patent application is a division of U.S. patent application Ser. No. 18/154,293 filed Jan. 13, 2023, which is a continuation-in-part of U.S. patent application Ser. No. 17/230,656 filed on Apr. 14, 2021 and titled “Dynamic Timed User Assessment Optimized Based on Time Available for Assessing,” which claims the priority benefit of U.S. Provisional Patent Application 63/009,545 filed Apr. 14, 2020 and titled “Dynamic Timed User Assessment Based on Multiple Data Sources,” the disclosures of which are incorporated by reference herein in their entireties.

### BACKGROUND

### Field of the Invention

The present disclosure generally pertains to generating analyses of user accounts dynamically within time constraints as data comes in, based on the time constraints and asynchronous receiving of the data. More specifically, the present disclosure pertains to generating an analyses of a user dynamically based on a duration of time available for responding to a request for the analyses of the user and based on optimal actions determined with respect to data sources in light of the duration of time available for generating the analysis.

### Description of the Related Art

Cards, such as cards and debit cards, can be used by customers during transactions with merchants at terminals. Terminals can read information from cards using card reader devices. Card reader devices include magnetic stripe reader devices that read card information from a magnetic stripe of a card that is swiped through a slot, Europay-Mastercard-Visa (EMV) chip reader devices that read card information from an EMV chip of a payment card that is inserted into a slot, or near field communication (NFC) reader devices that read card information wirelessly from an NFC-enabled card or other NFC device. Card reader devices read the card information from a card, then send that card information to a server associated with a processing entity in order to process the transaction by transferring asset(s) from a transferor account to a transferee account.

Cards or lines of credit can be provided to users by entities such as financial institutions or merchants. Traditionally, these entities undergo a thorough but lengthy analysis of a user before providing the user with a card, a line, or another modification to an existing account. This thorough analysis can be slow and inefficient, for example including waiting long periods of time (e.g., days) for data that may or may not end up being important for the analysis. Because of this, such analyses typically cannot be performed quickly (e.g., while a client is in a particular location). Alternately, these entities could undergo a shortened analysis of a user, which can lack thoroughness and miss important information even in situations when some of that information could be quickly obtained. By skipping what may be important data, such analyses can therefore have a low level of accuracy.

Some organizations have membership or loyalty programs that clients can register for, either through payment or for free. A client registered with a membership or loyalty program with a particular organization can receive benefits from the merchant, for example after the client transfers at least a certain amount of assets to the organization. Some cards may be branded or labeled according to a particular organization. Organizations with such branded cards may likewise grant benefits to clients. Some organizations even allow clients to sign up for a branded card within their locations. However, such organizations generally do not have access to detailed financial data for clients, and are not able to perform thorough analyses of the clients. Organizations may also have a limited amount of time to decide whether to offer a benefit to a client, for instance based on an amount of time that the client is physically present at the organization's location.

### SUMMARY

Systems and methods for dynamic time-dependent analysis are described. An analysis system determines an amount of time available for responding to a request regarding eligibility for a client account for a modification based on a confidence score for the client account. The analysis system transmits a first query and a second query. The analysis system uses trained machine learning model(s) to determine respective estimated receipt times of a first dataset that is response to the first query and of a second dataset that is responsive to the second queries. The analysis system uses the trained machine learning model(s) to determine respective importance levels of the first dataset and the second dataset to determining the confidence score. The analysis system generates a preliminary confidence score based on the first dataset. The analysis system delays generation of the confidence score until the second dataset is received, based on the estimated receipt times and importance levels. The analysis system updates the preliminary confidence score using the second dataset to generate the confidence score. The analysis system determines the eligibility determination (the eligibility of the client account for the modification) based on the confidence score, and transmits the eligibility determination. The analysis system updates the training of the machine learning models using training data, for instance including actual times to receive the first and second datasets, the estimated times to receive the first and second datasets, actual levels of importance of the first and second datasets to determining the confidence score (e.g., as measured based on an update amount between the preliminary confidence score and the confidence score), the estimated levels of importance of the first and second datasets to determining the confidence score, or a combination thereof.

In one example, a method of dynamic time-dependent asynchronous analysis is provided. The method includes: transmitting a first query and a second query for information about a client associated with a client account; generating, using at least one trained machine learning model and based on prior data store interactions, respective estimated times to receive a first dataset responsive to a first query and a second dataset responsive to a second query; determining, using the at least one trained machine learning model and based on prior confidence score determinations, respective estimated importance levels of the first dataset and the second dataset to determining a confidence score for the client; generating a preliminary confidence score for the client based on the first dataset while waiting for the second dataset to be received; delaying temporarily until the second dataset is received to pause generation of the confidence score for the client based on the estimated importance level of the second dataset reaching at least an importance threshold and based on the estimated time to receive the second dataset being within an amount of time for responding to a request; updating the preliminary confidence score by an update amount using the second dataset to generate the confidence score for the client; determining an eligibility of the client account for a modification based on a comparison between the confidence score and a confidence threshold; and training the at least one trained machine learning model further using training data to update the at least one trained machine learning model for at least one further client analysis, wherein the training data includes the update amount and respective times to receive the first dataset and the second dataset analysis.

In another example, a system for dynamic time-dependent analysis is provided. The system includes communication transceiver, a memory storing instructions, and a processor that executes the instructions. Execution of the instructions by the processor causes the processor to: transmit a first query and a second query for information about a client associated with a client account; generate, using at least one trained machine learning model and based on prior data store interactions, respective estimated times to receive a first dataset responsive to a first query and a second dataset responsive to a second query; determine, using the at least one trained machine learning model and based on prior confidence score determinations, respective estimated importance levels of the first dataset and the second dataset to determining a confidence score for the client; generate a preliminary confidence score for the client based on the first dataset while waiting for the second dataset to be received; delay temporarily until the second dataset is received to pause generation of the confidence score for the client based on the estimated importance level of the second dataset reaching at least an importance threshold and based on the estimated time to receive the second dataset being within an amount of time for responding to a request; update the preliminary confidence score by an update amount using the second dataset to generate the confidence score for the client; determine an eligibility of the client account for a modification based on a comparison between the confidence score and a confidence threshold; and train the at least one trained machine learning model further using training data to update the at least one trained machine learning model for at least one further client analysis, wherein the training data includes the update amount and respective times to receive the first dataset and the second dataset analysis.

In another example, a non-transitory computer readable storage medium having embodied thereon a program is provided. The program is executable by a processor to perform a method of dynamic time-dependent analysis. The method includes: transmitting a first query and a second query for information about a client associated with a client account; generating, using at least one trained machine learning model and based on prior data store interactions, respective estimated times to receive a first dataset responsive to a first query and a second dataset responsive to a second query; determining, using the at least one trained machine learning model and based on prior confidence score determinations, respective estimated importance levels of the first dataset and the second dataset to determining a confidence score for the client; generating a preliminary confidence score for the client based on the first dataset while waiting for the second dataset to be received; delaying temporarily until the second dataset is received to pause generation of the confidence score for the client based on the estimated importance level of the second dataset reaching at least an importance threshold and based on the estimated time to receive the second dataset being within an amount of time for responding to a request; updating the preliminary confidence score by an update amount using the second dataset to generate the confidence score for the client; determining an eligibility of the client account for a modification based on a comparison between the confidence score and a confidence threshold; and training the at least one trained machine learning model further using training data to update the at least one trained machine learning model for at least one further client analysis, wherein the training data includes the update amount and respective times to receive the first dataset and the second dataset analysis.

In another example, a system for dynamic time-dependent analysis is provided. The system includes: means for transmitting a first query and a second query for information about a client associated with a client account; means for generating, using at least one trained machine learning model and based on prior data store interactions, respective estimated times to receive a first dataset responsive to a first query and a second dataset responsive to a second query; means for determining, using the at least one trained machine learning model and based on prior confidence score determinations, respective estimated importance levels of the first dataset and the second dataset to determining a confidence score for the client; means for generating a preliminary confidence score for the client based on the first dataset while waiting for the second dataset to be received; means for delaying temporarily until the second dataset is received to pause generation of the confidence score for the client based on the estimated importance level of the second dataset reaching at least an importance threshold and based on the estimated time to receive the second dataset being within an amount of time for responding to a request; means for updating the preliminary confidence score by an update amount using the second dataset to generate the confidence score for the client; means for determining an eligibility of the client account for a modification based on a comparison between the confidence score and a confidence threshold; and means for training the at least one trained machine learning model further using training data to update the at least one trained machine learning model for at least one further client analysis, wherein the training data includes the update amount and respective times to receive the first dataset and the second dataset. analysis,

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

In some aspects, one or more of the methods, apparatuses, and computer-readable medium described above further comprise: determining, based on a time that a request is received, an amount of time for responding to the request with an eligibility of a client for a modification to a client account of the client based on the confidence score determined for the client.

In some aspects, one or more of the methods, apparatuses, and computer-readable medium described above further comprise: transmitting an indication of the eligibility of the client account for the modification.

In some aspects, generating the preliminary confidence score for the client based on the first dataset includes generating the preliminary confidence score using the at least one trained machine learning model based on input of the first dataset into the at least one trained machine learning model. In some aspects, updating the preliminary confidence score using the second dataset to generate the confidence score for the client includes generating the confidence score for the client using the at least one trained machine learning model based on input of the first dataset and the second dataset into the at least one trained machine learning model.

In some aspects, the training data also includes at least one of the preliminary confidence score or the confidence score for the client. In some aspects, the training data also includes at least one of the respective estimated times to receive the first dataset and the second dataset or the respective estimated importance levels of the first dataset and the second dataset to determining the confidence score for the client.

In some aspects, transmitting the first query and the second query includes transmitting the first query in parallel with transmitting the second query. In some aspects, transmitting the first query and the second query includes transmitting the first query and the second query serially.

In some aspects, the confidence score for the client corresponds to a worthiness of the client account for the modification, and wherein the modification to the client account includes at least one of a new account or a limit increase.

In some aspects, one or more of the methods, apparatuses, and computer-readable medium described above further comprise: transmitting a third query; generating, using the at least one trained machine learning model and based on the prior data store interactions, an estimated time to receive a third dataset responsive to the third query; and determining, using the at least one trained machine learning model and based on the prior confidence score determinations, an estimated importance level of the third dataset to determining the confidence score for the client; wherein pausing temporarily until the second dataset is received includes pausing temporarily until the third dataset is also received to delay generation of the confidence score for the client based on the estimated importance level of the third dataset reaching at least the importance threshold and based on the estimated time to receive the second dataset being within the amount of time for responding to the request; and wherein updating the preliminary confidence score using the second dataset to generate the confidence score for the client includes updating the preliminary confidence score also using the third dataset to generate the confidence score for the client.

In some aspects, one or more of the methods, apparatuses, and computer-readable medium described above further comprise: transmitting a third query; generating, using the at least one trained machine learning model and based on the prior data store interactions, an estimated time to receive a third dataset responsive to the third query; and determining not to wait to receive the third dataset to generate the confidence score for the client based on the estimated time to receive the third dataset failing to be within the amount of time for responding to the request.

In some aspects, one or more of the methods, apparatuses, and computer-readable medium described above further comprise: transmitting a third query; determining, using the at least one trained machine learning model and based on the prior confidence score determinations, an estimated importance level of a third dataset to determining the confidence score for the client, wherein the third dataset is responsive to the third query; and determining not to wait to receive the third dataset to generate the confidence score for the client based on the estimated importance level of the third dataset failing to reach at least the importance threshold.

In some aspects, one or more of the methods, apparatuses, and computer-readable medium described above further comprise: transmitting a third query; and updating the preliminary confidence score using a third dataset to generate an intermediate confidence score for the client, wherein the third dataset is responsive to the third query, wherein updating the preliminary confidence score using the second dataset to generate the confidence score includes updating the intermediate confidence score using the second dataset to generate the confidence score.

In some aspects, one or more of the methods, apparatuses, and computer-readable medium described above further comprise: transmitting a third query; generating an updated confidence score for the client based on a third dataset after updating the preliminary confidence score for the client to generate the confidence score for the client, wherein the third dataset is responsive to the third query; identifying a change in the eligibility of the client account for the modification based on a comparison between the updated confidence score for the client and the confidence threshold; and transmitting an indication of the change in the eligibility of the client account for the modification.

In some aspects, the training data includes a second update amount indicative of a difference between the updated confidence score for the client and the confidence score for the client.

In some aspects, a score grading the client account is included in at least one of the first dataset or the second dataset.

In some aspects, one or more of the methods, apparatuses, and computer-readable medium described above further comprise: receiving the first dataset and the second dataset from a data store, wherein the prior data store interactions identify at least one interaction with the data store.

In some aspects, one or more of the methods, apparatuses, and computer-readable medium described above further comprise: receiving the first dataset from a first data store; and receiving the second dataset from a second data store, wherein the prior data store interactions identify at least a first interaction with the first data store and at least a second interaction with the second data store.

In some aspects, one or more of the methods, apparatuses, and computer-readable medium described above further comprise: determining that the second dataset is receivable from a first data store and a second data store; determining that a second estimated time to receive the second dataset from the first data store is not within the amount of time for responding to the request; determining that the estimated time to receive the second dataset is within the amount of time for responding to the request, wherein the estimated time to receive the second dataset corresponds to receiving of the second dataset from the second data store; and receiving the second dataset from the second data store.

In some aspects, one or more of the methods, apparatuses, and computer-readable medium described above further comprise: determining that the first dataset is receivable from a first data store and a second data store; determining that a second estimated time to receive the first dataset from the first data store is not within the amount of time for responding to the request; determining that the estimated time to receive the first dataset is within the amount of time for responding to the request, wherein the estimated time to receive the first dataset corresponds to receiving of the first dataset from the second data store; and receiving the first dataset from the second data store.

In some aspects, the confidence threshold is based on the prior confidence score determinations. account score In some aspects, the apparatus includes a mobile device, a mobile telephone, a smart phone, a mobile handset, a wireless communication device, a personal computer, a laptop computer, a server computer, or another computing device.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating a system architecture for a user analysis and decisioning system.

FIG. 2 is a block diagram illustrating operations and components of a user analysis and decisioning system for dynamic timed decisioning.

FIG. 3 is a flow diagram illustrating operations for dynamic timed decisioning.

FIG. 4 is a block diagram illustrating a system architecture of a data lake system for analysis of time-based event data.

FIG. 5 is a block diagram illustrating operations and components of a user analysis and decisioning system with self-healing micro-services.

FIG. 6 is a block diagram illustrating a system architecture of a data lake system for self-healing micro-services.

FIG. 7 is a flow diagram illustrating a process for dynamic timed decisioning.

FIG. 8 is a block diagram illustrating a system architecture of a user analysis and decisioning system with an analysis engine, a choreography engine, and a strategy engine.

FIG. 9 is a block diagram illustrating a system architecture of a user analysis and decisioning system with a communication system, an analysis system, and a strategy system.

FIG. 10 is a flow diagram illustrating a process for dynamic time-dependent analysis.

FIG. 11 is a block diagram illustrating operations for dynamic time-dependent analysis.

FIG. 12 is a block diagram illustrating operations for dynamic time-dependent analysis.

FIG. 13 is a block diagram of an exemplary computing device that may be used to implement some aspects of the technology.

### DETAILED DESCRIPTION

Techniques and technologies for time-dependent analysis are described herein. An analysis system can determine an amount of time available for responding to a request regarding eligibility for a client account for a modification based on a confidence score for a client associated with the client account. The analysis system transmits a first query and a second query. The analysis system uses trained machine learning model(s) to determine respective estimated receipt times of a first dataset that is response to the first query and of a second dataset that is responsive to the second queries. The analysis system uses the trained machine learning model(s) to determine respective importance levels of the first dataset and the second dataset to determining the confidence score. The analysis system generates a preliminary confidence score based on the first dataset. The analysis system delays generation of the confidence score until the second dataset is received, based on the estimated receipt times and importance levels. The analysis system updates the preliminary confidence score using the second dataset to generate the confidence score. The analysis system determines the eligibility determination (the eligibility of the client account for the modification) based on the confidence score, and transmits the eligibility determination. The analysis system updates the training of the machine learning models using training data, for instance including actual times to receive the first and second datasets, the estimated times to receive the first and second datasets, actual levels of importance of the first and second datasets to determining the confidence score (e.g., as measured based on an update amount between the preliminary confidence score and the confidence score), the estimated levels of importance of the first and second datasets to determining the confidence score, or a combination thereof.

The systems and methods described herein produce various technical improvements. Technical improvements provided by a systems and methods described herein may include, for example, improved efficiency in generating and providing an analysis of a client, for example based on determination of optimal actions for generating the analyses (e.g., whether to wait to receive a particular dataset to use for generating an analysis based on an estimated time to receive the dataset and/or an estimated importance of the dataset to generating the analysis) within a duration of time available for responding to the request. Technical improvements also include increased reliability in providing the analysis, since the duration of time available for responding to the request is adhered to and the dynamic time-dependent asynchronous analysis system flexibly handles issues such as nonresponsive data sources without sacrificing provision of the analyses in a timely manner. The efficiency and reliability here also does not sacrifice security, as discussed herein with respect to fraud detection rules 860 for example, and allows the analysis for the analyses generated by the dynamic time-dependent asynchronous analysis system to be as thorough as possible given the duration of time available for responding to the request. Further technical improvements include increased efficiency and reliability for client devices that send the request for the analyses of the user and that receive the analyses of the user from the dynamic time-dependent asynchronous analysis system. Because these client devices can perform transactions such as providing users with cards or lines of credit, the technical improvements to the dynamic time-dependent asynchronous analysis system mean improvements to the efficiency and reliability of systems for provision of cards, lines of credit, or other transactions.

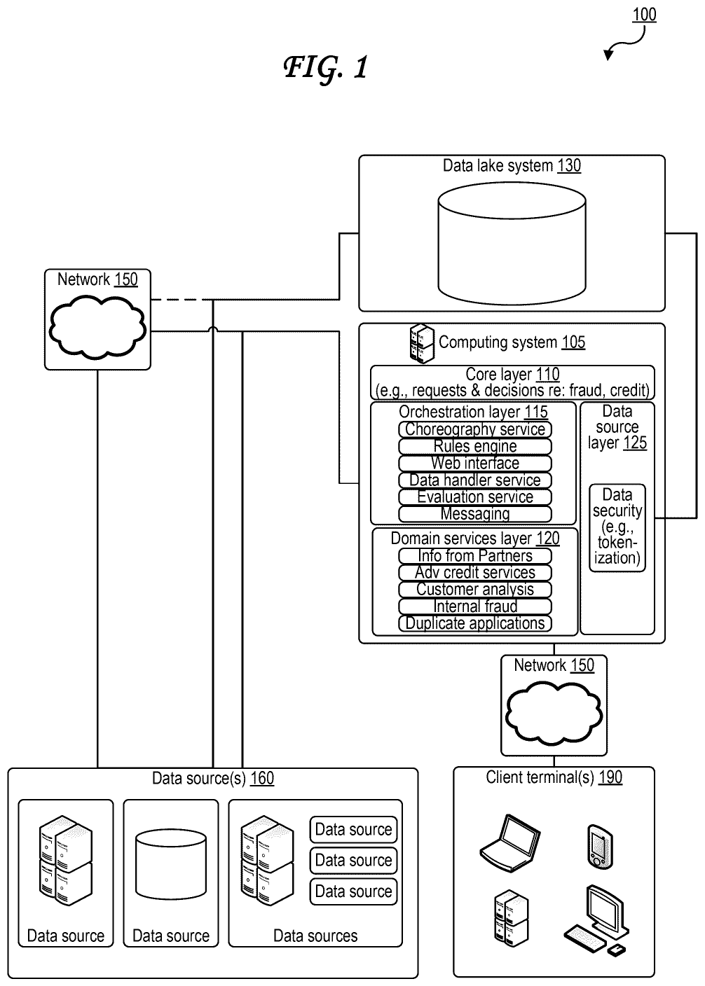

FIG. 1 is a block diagram illustrates a system architecture 100 for a user analysis and decisioning system. In particular, the architecture 100 of FIG. 1 includes a computing system 105 coupled to a data lake system 130. The computing system 105 and the data lake system 130 are coupled to one or more data source(s) 160, either directly, through a network connection over a network 150 (e.g., a public network 150 such as the Internet and/or a private network 150 such as a LAN and/or WLAN), or some combination thereof. The computing system 105 is coupled to one or more client terminals 190 over a network connection over a network 150 (e.g., a public network 150 such as the Internet and/or a private network 150 such as a LAN and/or WLAN). In some cases, the computing system 105 may be referred to as the remote computing system, the network computing system, the server system, the unit of compute, the unit of computing, or some combination thereof.

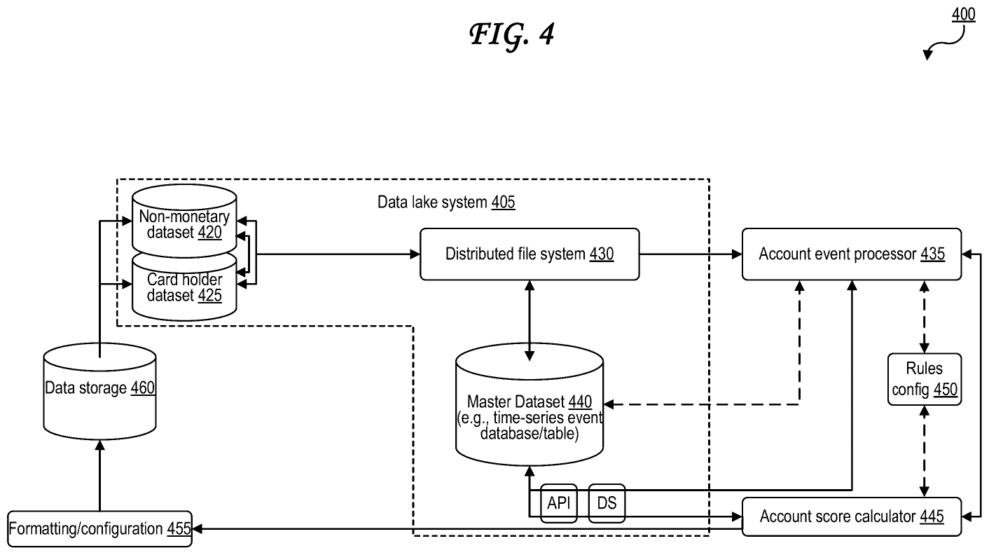

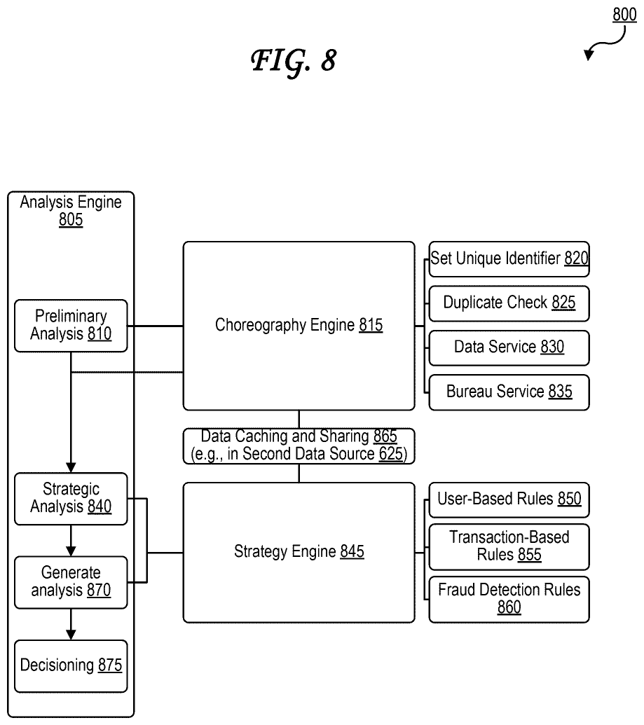

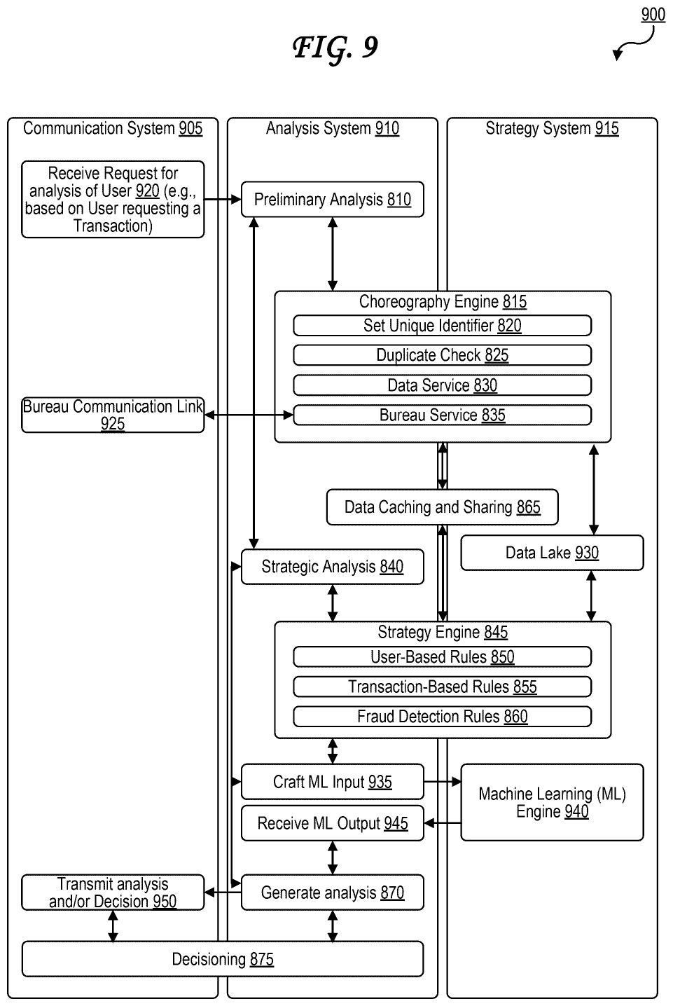

The computing system 105 includes various systems running various system layers, including a core layer 110, an orchestration layer 115, a domain services layer 120, and a data source layer 125. The core layer 110 may receive (e.g., from client terminals 190) requests for analyses and decisions about a user, the analyses and decisions generally relating to fraud, account worthiness (e.g., creditworthiness), financial well-being, other types of analyses, or some combination thereof. The orchestration layer 115 includes tools enabling the core layer 110 to generate the analyses and decisions, including a choreography service that queues and schedules requests and analysis generation, a rules engine that provides rules for making analyses and decisions, a web interface for the client terminal(s) 190, a data handler that handles receipt of data from the data lake system 130 and transmission of data to the data lake system 130, an evaluation service that generates analyses based on the data from the data lake system 130 and the rules from the rules engine, and a messaging service that allows the various layers and services of the computing system 105 to interact with one another and with the data lake system 130. The domain services layer 120 provide services for the client terminal(s) 190 using the orchestration layer 115 and data source layer 125, such as sharing of information from partner organizations, advanced services, customer analyses, internal fraud analyses, and duplicate applications. The data source layer 125 interacts with and handles receipt of data from the data lake system 130 and transmission of data to the data lake system 130, and may include data security precautions such as a firewall and/or a data tokenization service. In some examples, the rules of the rules engine of FIG. 1 may include the rules of the rules engine (block 235), the rules of the rules configuration 450 of FIG. 4, the user-based rules 850 of FIGS. 8-9, the transaction-based rules 855 of FIGS. 8-9, the fraud detection rules 860 of FIGS. 8-9, or a combination thereof.

The data lake system 130 may include one or more databases, for example one or more time-series databases. The data lake system 130 may retrieve, organize, and store data. The data that is retrieved, organized and stored by the data lake system may include data from the various data sources 160, data (e.g., requests) received from client terminals 190), data (e.g., decisions and analyses and analyses) generated by the computing system 105, or some combination thereof. The data lake system architecture 400 of FIG. 4 is one example of a data lake system 130.

The data sources 160 may include various types of data sources. For example, a set of one or more computers included in the data sources 160 may itself be a data source. A hard drive or other computer-readable storage medium may be a data source, particularly when read by a computing device of the data sources 160. A set of one or more computing devices included in the data sources 160 may include multiple disparate data sources, for example one data source with transaction history, one data source with address changes, one data source with name changes, and so forth. The computing system 105 and data lake system 130 may retrieve data from any combination of the various data sources, and various types of data sources, of the data sources 160.

The client terminals 190, which may be referred to as client devices, may include various computing devices used by clients. The client terminals 190 may transmit requests to the computing system 105 over the network 150, and may receive responses back from the computing system 105 over the network 150. The requests may be requests for analyses of one or more users, and the responses may be the analyses of the one or more users as generated by the computing system 105. In some cases, client terminals 190 may be POS devices at merchant locations, where the merchant is trying to determine whether to allow a customer to enroll in a card and/or account associated with the merchant, and is relying on receiving an analysis of the customer to make this determination.

As discussed further herein, these analyses may be generated by the computing system 105 based on a variety of types of information about the user retrieved by the computing system 105 from the data lake system 130 and/or data sources 160. The analyses may include account scores or scores corresponding to a account worthiness of the user. The analyses may be decisions, which may be made based on whether or not the account scores or scores exceed or fall below a predetermined account score or score threshold. The decisions may include decisions as to whether or not to grant the user a new account (e.g., a new card associated with an account), a limit increase (e.g., on an existing account), or some combination thereof.

The computing system 105, data lake system 130, client terminals 190, and data sources 160 all may include one or more computing system 1300 and/or may include at least a subset of the components of a computing system 1300.

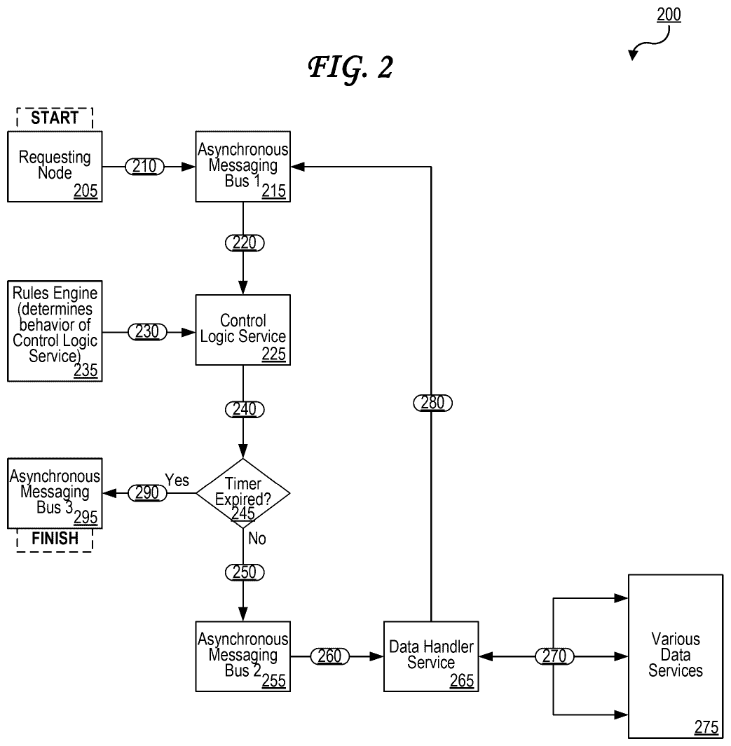

FIG. 2 is a block diagram 200 illustrating operations and components of a user analysis and decisioning system for dynamic timed decisioning. The block diagram 200 of FIG. 2 illustrates dynamic timed decisioning operations. The operations may, in some cases, start at block 205, as indicated by the dashed “start” block. The operations may, in some cases, end at block 295, as indicated by the dashed “end” block.

Block 205) represents a requesting node, which may be a client terminal 190. The requesting node block 205 transmits a message 210 to the asynchronous messaging bus 1 block 2 (block 215). In some cases, the message 210 may use a specific schema, which may for instance include formatting, syntax, and data types. For instance, the schema may be denoted in Extensible Markup Language (XML) or another type of markup language. The schema may indicate that certain variables corresponding to timers, data, rules, and so forth should hold certain data types, such as integers, strings, characters, floating point numbers, fixed point numbers, big integers, Boolean values, enumerated values, or other data types.

The asynchronous messaging bus 1 block 2 (block 215) is part of the computing system 105. The message may include a request for an analysis of a user, such as a request for an account decision. The asynchronous messaging bus 1 block 2 (block 215) transmits the request on to the control logic service (block 225) within the message 220. The message 220 may preserve the schema of the message 210, for instance by preserving the formatting/syntax and/or by preserving the data types of the different variables. The control logic service (block 225) is an example of the evaluation service of the orchestration layer 115 of the computing system 105 of FIG. 1. The control logic service (block 225) may also receive rules (block 230) from the rules engine (block 235), which may also be part of the orchestration layer 115 of the computing system 105 of FIG. 1. In some examples, the rules of the rules engine (block 235) may include the rules of the rules engine of FIG. 1, the rules of the rules configuration 450 of FIG. 4, the user-based rules 850 of FIGS. 8-9, the transaction-based rules 855 of FIGS. 8-9, the fraud detection rules 860 of FIGS. 8-9, or a combination thereof.

The control logic service (block 225) performs a process that begins a timer and begins the process of generating an analysis of the user to respond to the request from the message 210. At a decision point 245, the control logic service (block 225) determines if the time has expired. If the timer has not expired at the decision point 245, the control logic service (block 225) may update the message 220 in some cases, for example to generate and add to the message 220 a preliminary analysis of the user while preserving the schema of the message 210. The message 240 and/or the message 250 may thus include the preliminary analysis. The control logic service (block 225) sends the updated message on to the asynchronous messaging bus 2 (block 255) as the message 250). The message 250 is sent on from the asynchronous messaging bus 2 (block 255) to the data handler service (block 265) as the message 260. The data handler service (block 265) may also be part of the orchestration layer 115 of the computing system 105 of FIG. 1.

The data handler service (block 265) communicates with various data services (block 275) over one or more communications 270. The one or more communications 270 include requests for information about the user transmitted by the data handler service (block 265) to the various data services (block 275). The various data services (block 275) may include the data sources 160 of FIG. 1. The one or more communications 270 include datasets of information about the user transmitted by the various data services (block 275) back to the data handler service (block 265). The data handler service (block 265) retrieves one or more of the datasets from the various data sources (block 275) and updates the message 260 into the message 280, which includes information from the one or more retrieved datasets, and which the data handler service (block 265) sends to the asynchronous messaging bus 1 (block 215). Updating the message may include updating, in real-time (or near real-time) as communications 270 and/or the message 280 are being received (e.g., from the various data services (block 275), data sources, and/or data structures) (e.g., constantly and/or continuously), the preliminary analysis (or an intermediate analysis) into a final analysis, or into an intermediate analysis on the way to generating the final analysis. The message 280) may preserve the schema of the message 210. In some cases, preserving the schema of the message 210 may include reformatting or converting newly received data from the data sources (block 275) from one or more schema(s) used by the data sources (block 275) to fit into the existing schema of the message 210. For example, data received from the data sources (block 275) may be parsed and a particular element of data may be extracted, and that element of data may then be inserted into a field in the message 280 using the existing schema of the message 210. The data handler service (block 265) need not wait until it receives all of the datasets from the various data services (block 275) that are responsive to the requests that the data handler service (block 265) sent to the various data services (block 275). In some examples, the data handler service (block 265) can determine whether or not to wait for certain datasets based on estimated times to receive those datasets (compared to the timer from decision point 245) and/or based on estimated levels of importance of those datasets to generating the final analysis.

Once the asynchronous messaging bus 1 (block 215) receives the message 280) from the data handler service (block 265), the asynchronous messaging bus 1 (block 215) sends the message 280 back to the control logic service as the message 220. The control logic service (block 225) considers the new information from the data handler service (block 265) and updates the message with an analysis of the user that it generates based on the new information from the data handler service (block 265) and based on the rules (block 230) from the rules engine (block 235). Updating the message may include updating, in real-time (or near real-time) as communications 270 and/or the message 280 are received (e.g., from the various data services (block 275), data sources, and/or data structures) (e.g., constantly and/or continuously), the preliminary analysis (or an intermediate analysis) into a final analysis, or into an intermediate analysis on the way to generating the final analysis. The data handler service (block 265) again determines at decision point 245 whether the timer has expired. If the timer has not expired at the decision point 245, the process with blocks 255, 265, 275, 215, 225, communications 270, and messages 250, 260, 280, 220, and 240 repeats for another cycle, with the data handler service (block 265) potentially receiving additional datasets from the various data sources (block 275) that are responsive to the requests that the data handler service (block 265) sent to the various data services (block 275), and the control logic service (block 225) may update its analysis based on the additional information from the data handler service (block 265).

If the timer has expired at the decision point 245, the message that is continually updated and that now includes the analysis generated by the control logic service (block 225) is transmitted to the asynchronous messaging bus 3 (block 295) as message 290. The asynchronous messaging bus 3 (block 295) sends the message 290 back to the requesting node (block 205), or to another service (not pictured) within the computing system 105 that sends the message 290 on to the requesting node (block 205). Thus, the requesting node (block 205) receives the analysis of the user generated by the control logic service (block 225).

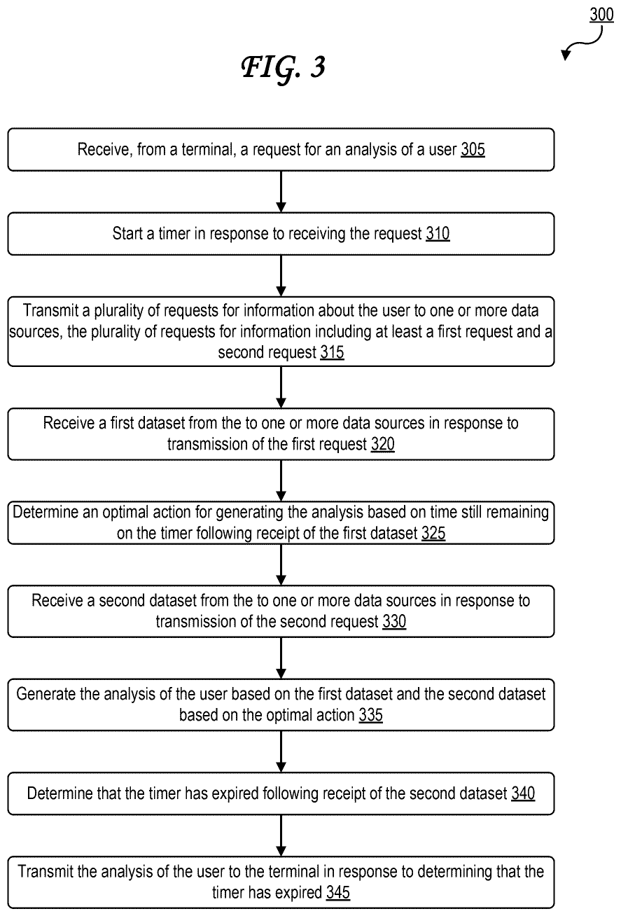

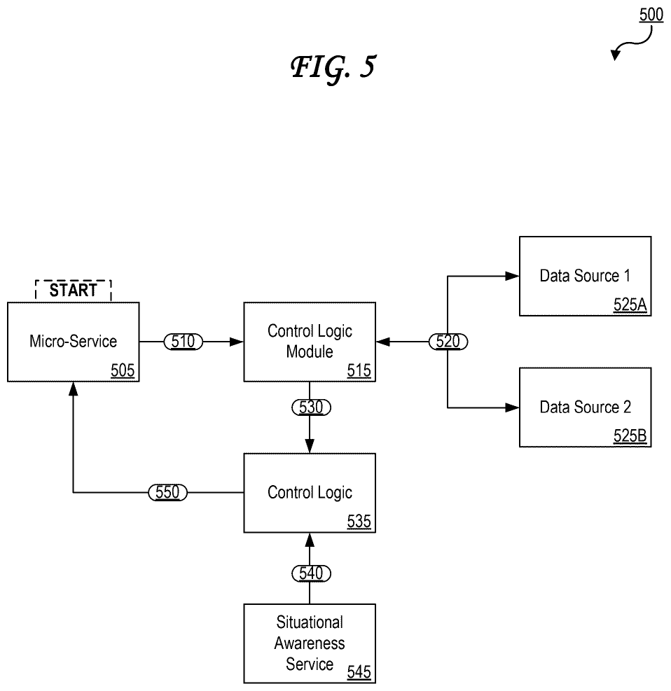

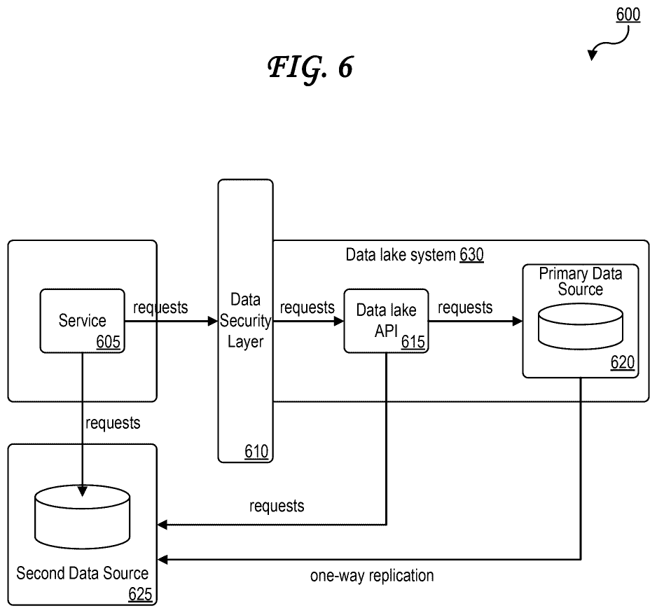

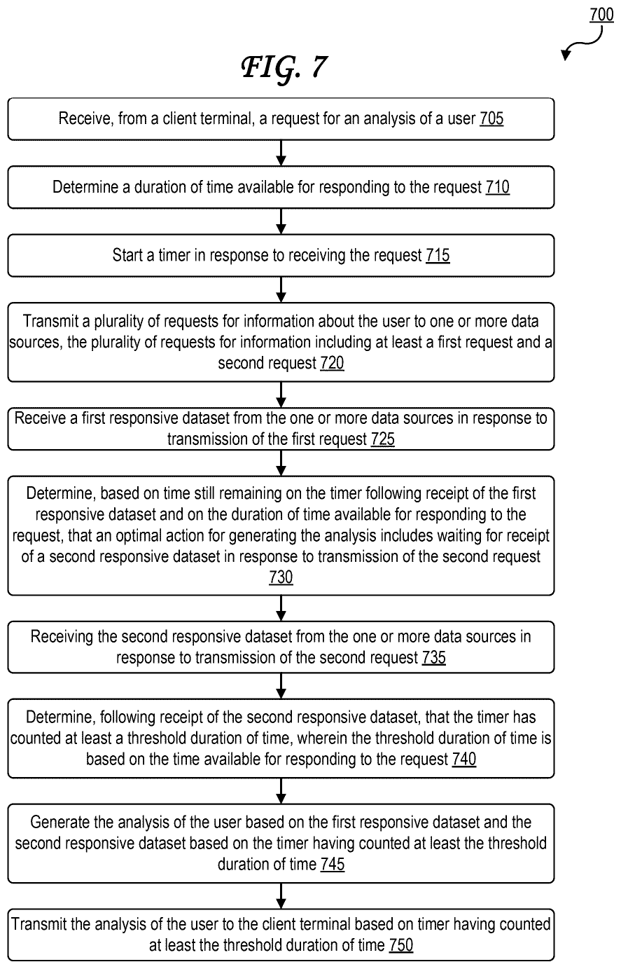

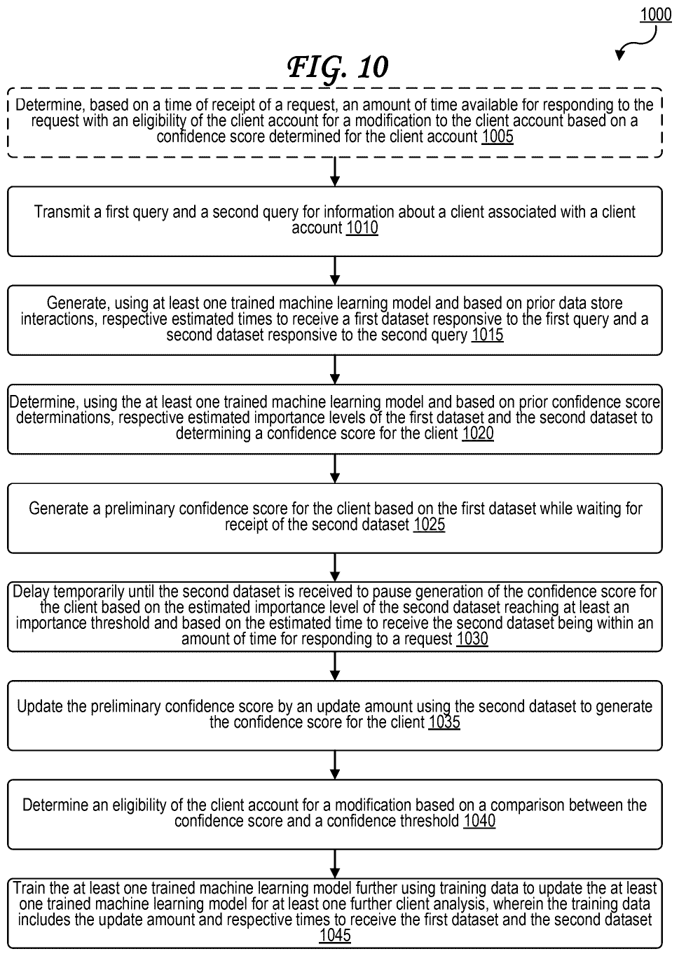

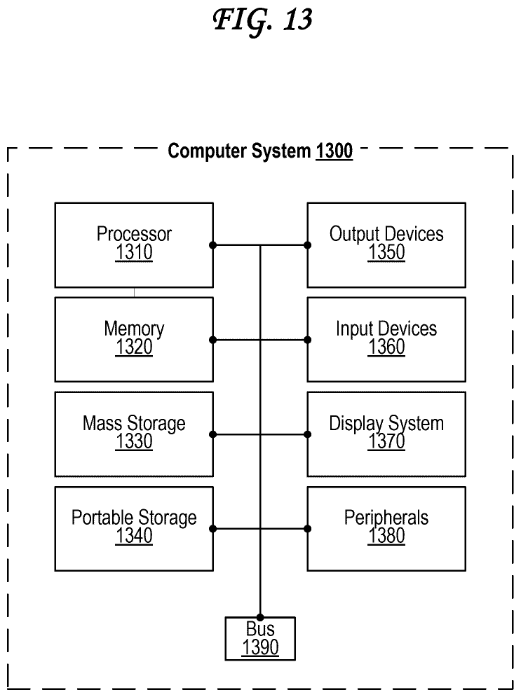

FIG. 3 is a flow diagram illustrating a process 300 for dynamic timed decisioning. The process 300 of FIG. 3 are performed by a dynamic time-dependent asynchronous analysis system. The dynamic time-dependent asynchronous analysis system may be, and/or may include, the computing system 105 of FIG. 1, the data lake system 130 of FIG. 1, the user analysis and decisioning system of FIG. 2, the data lake system of FIG. 4, the user analysis and decisioning system of FIG. 5, the data latke system of FIG. 6, the dynamic time-dependent asynchronous analysis system of FIG. 7, the user analysis and decisioning system 800 of FIG. 8, the user analysis and decisioning system 900 of FIG. 9, the dynamic time-dependent analysis system of FIG. 10, the ML engine 1120, the ML model(s) 1125, the ML model(s) 1225, the computing system 1300 of FIG. 13, or a combination thereof.

At operation 305, the dynamic time-dependent asynchronous analysis system receives from a terminal (e.g., a client terminal 190), a request for an analysis of a user. The terminal can include, for example, the client terminal 190 of FIG. 1, the requesting node (block 205) of FIG. 2, the client terminal of operations 705 and 750, a user device associated with the user, a merchant device associated with a merchant, a financial institution device associated with a financial institution, an account institution device associated with an account institution, or a combination thereof. The request for the analysis of the user may be received based on the user requesting a transaction, such as one or more purchases by the user from the entity, rentals by the user from the entity, applications for credit (e.g., for a new line, a new loan, a new card) by the user from the entity, changes to credit (e.g., requesting a limit increase or other adjustment to a line) by the user from the entity, or a combination thereof. Operations 705 and/or 920 may be examples of operation 305, and vice versa.

At operation 310, the dynamic time-dependent asynchronous analysis system starts a timer in response to receiving the request. The timer may be the timer of FIG. 2 and/or the timer of FIG. 7. The timer may start from the time of receipt of the request for the analysis of the user. The timer may start from the time of transmission of the request for the analysis of the user. The timer may start a time at which one of the operations 305-335 occurs, begins, or completes.

At operation 315, the dynamic time-dependent asynchronous analysis system transmits a plurality of requests for information about the user to one or more data sources. The plurality of requests for information include at least a first request and a second request. In some cases, the requests may be referred to as queries, and transmitting the requests may be referred to as querying a data source. The one or more communications 270 to the various data services (block 275) of FIG. 2 may be examples of the plurality of requests for information about the user transmitted to the one or more data sources of operation 720. The one or more communications 520 sent to the data source 1 525A and/or the data source 2 525B of FIG. 2 may be examples of the plurality of requests for information about the user transmitted to the one or more data sources of operation 720. The one or more requests sent from the service 605 of FIG. 6 may be examples of the plurality of requests for information about the user transmitted to the one or more data sources of operation 720. Examples of the one or more data sources may include the various data services (block 275), the data lake system 405, the master dataset 440, the account score calculator 445, the data storage system 460, the non-monetary dataset 420, the card holder dataset 425, the distributed file system 430, the data source 1 525A, the data source 2 525B, the primary data source 620, the second data source 625, the data lake system 630, the data lake 930, or a combination thereof. Operation 720 may be an example of operation 315, or vice versa.

At operation 320, the dynamic time-dependent asynchronous analysis system receives a first dataset from the to one or more data sources in response to transmission of the first request. The one or more communications 270 from the various data services (block 275) of FIG. 2 may be examples of responsive datasets such as the first dataset. The one or more communications 520 received from the data source 1 525A and/or the data source 2 525B of FIG. 5 may be examples of the first dataset from the one or more data sources. The first responsive dataset of operation 725 may be an example of the first dataset of operation 320, or vice versa. Operation 725 may be an example of operation 320, or vice versa.

At operation 325, the dynamic time-dependent asynchronous analysis system determines an optimal action for generating the analysis based on time still remaining on the timer following receipt of the first dataset. The optimal decision can be determined real-time (or near real-time) as the dynamic time-dependent asynchronous analysis system receives data (e.g., the first dataset, the second dataset, and/or other responsive datasets) (e.g., constantly and/or continuously) and/or waits to receive data (e.g., the first dataset, the second dataset, and/or other responsive datasets) (e.g., constantly and/or continuously). The timer may count up or down, and may count as “expired” when the timer has counted a threshold duration of time that is based on a duration of time available for responding to the request of operation 305. Decision point 245 may be an example of operation 325, or vice versa. Operation 730 may be an example of operation 325, or vice versa.

At operation 330, the dynamic time-dependent asynchronous analysis system receives a second dataset from the to one or more data sources in response to transmission of the second request. The one or more communications 270 from the various data services (block 275) of FIG. 2 may be examples of responsive datasets such as the second dataset. The one or more communications 520 received from the data source 1 525A and/or the data source 2 525B of FIG. 5 may be examples of the second dataset from the one or more data sources. The second responsive dataset of operation 735 may be an example of the second dataset of operation 330, or vice versa. Operation 735 may be an example of operation 330, or vice versa.

At operation 335, the dynamic time-dependent asynchronous analysis system generates the analysis of the user based on the first dataset and the second dataset based on the optimal action. The dynamic time-dependent asynchronous analysis system can generate the analysis in real-time (or near real-time) as the second dataset is received (and/or as other datasets are being received, and/or as other analyses regarding other clients are being generated). The account score generated by the account score calculator 445 may be an example of the analysis of operation 335. The analysis generated at the generate analysis 870 operation of FIGS. 8 and/or 9 may be examples of the analysis of operation 335. The decision generated at the decisioning 875 operation of FIGS. 8 and/or 9 be examples of the analysis of operation 745. Operation 745 may be an example of operation 335, or vice versa.

At operation 340, the dynamic time-dependent asynchronous analysis system determines that the timer has expired following receipt of the second dataset, and in some cases following generation of the analysis of the user. The timer may count up or down, and may count as “expired” when the timer has counted a threshold duration of time that is based on a duration of time available for responding to the request. Decision point 245 may be an example of operation 340, or vice versa. Operation 740 may be an example of operation 340, or vice versa.

At operation 345, the dynamic time-dependent asynchronous analysis system, transmits the analysis of the user to the terminal in response to determining that the timer has expired. The transmission of the analysis and/or decision operation 950 of FIG. 9 may be an example of the transmission of the analysis of the user to the client terminal of operation 345. Operation 750 may be an example of operation 345, or vice versa.

Regarding operation 325, the optimal action may, in some cases, be determined based on how much time remains on the timer, on pre-determined priorities (e.g., levels of importance or weight values in determining in the analysis) associated with certain data sources and types of data from those data sources, on whether a query has been sent to the data source already, on when the query was sent to the data source, on estimates of how much time it will take to receive the types of data in question from those data sources, on estimates of how much time it will take to process the types of data in question from those data sources upon receipt, whether data can be used alone in generating the analysis or requires additional data from another source to be used in generating the analysis, or some combination thereof. For example, if five data sources are queried and the first and third are highest priority, but the third will take too long (more than remains on the timer) to receive data from and/or to process the data into a form that is useful for generating, and the fourth and fifth are only useful if they are both received and processed within the time remaining on the timer, then the optimal action may be to use data from the first and second data sources.

In some cases, the pre-determined priorities may be updated by the dynamic time-dependent asynchronous analysis system as the dynamic time-dependent asynchronous analysis system receives more data and generates more analyses, for instance based on how accurate those analyses turn out to be. If feedback is received indicating that an analysis was inaccurate, then the priorities of data used in that analysis may be dropped by a predetermined amount. If feedback is received indicating that an analysis was accurate, then the priorities of data used in that analysis may be increased by a predetermined amount, or kept the same. The dynamic time-dependent asynchronous analysis system may use a trained machine learning (ML) algorithm, such as a trained neural network (NN), to update the priorities based on feedback. Priorities may be associated with data sources, with data types, or some combination thereof. Similarly, estimates for how much time it will take to receive and/or process a particular type of data from a particular data source may be updated based on how much time it actually takes to receive and/or process that particular type of data from that particular data source during previous executions of the process 300. The dynamic time-dependent asynchronous analysis system may use a machine learning algorithm, such as a neural network, to update the time estimates based on measured times used as training data.

Regarding operation 335, in some cases the analysis is generated within the time allotted by the timer (e.g., before the time expires), while in other cases, the analysis is generated after the timer expires. If the dynamic time-dependent asynchronous analysis system's rules require the analysis to be generated within the time allotted by the timer (e.g., before the time expires), then the optimal action may include generation of the analysis. Operation 335, and must take into account any processing time required to generate the analysis At operation 335. If the analysis is generated before the timer expires, then the determination that the timer has expired. Operation 340 may occur following generation of the analysis in addition to following receipt of the second dataset.

In some cases, the requests that are transmitted from the dynamic time-dependent asynchronous analysis system to the data sources. Operation 315 may include amounts of time within which the dynamic time-dependent asynchronous analysis system requests a response from the data source. This amount of time may be based on a remaining time on the timer. For instance, if the remaining time on the timer is 500 ms, the request may indicate that the data should be received within 500 ms, or even within a smaller amount of time, such as 400 ms or 300 ms, in order to reserve time for processing the received data to generate the analysis and/or for ultimately generating the analysis based on the data. In some cases, a request may be submitted to multiple data sources with the time amount, so that the multiple data sources can bid on which of them can provide the requested data within the requested time, most cheaply, fastest, or some combination thereof.

FIG. 4 is a system architecture block diagram for a data lake system for analysis of time-based event data.

The architecture 400 of FIG. 4 includes a data lake system 405. The data lake system 130 of FIG. 1 may include at least a subset of the data lake system 405, at least a subset of the architecture 400, or some combination thereof. The architecture 400 and/or the data lake system 405 may in some cases include elements of the computing system 105 of FIG. 1.

The data lake system 405 includes a non-monetary dataset 420, a card holder dataset 425, a distributed file system 430, and a master dataset 440. The non-monetary dataset 420 may include non-monetary information about various users, such as users' names, addresses, telephone numbers, marriage status, and the like. The card holder dataset 425 financial data associated with one or more users, for example transaction histories of the users, accounts associated with the users, credit limits of the users, Fair Isaac Corporation (FICO)® account scores of the users, credit bureau ratings (CBR) of users, VantageScores® of users, Stripe® Radar® scores of users, and the like. The master dataset 440 may be, or may include, a time-series event database or table.

The data lake system 405 periodically polls the non-monetary dataset 420 and filters only data needed to populate the time-series event database/table of the master dataset 440, which is transferred to the distributed file system 430. The data lake system 405 analyzes the data from the non-monetary dataset 420 that is in the distributed file system 430 to determine particular card holder accounts to read from the card holder dataset 425. The data lake system 405 then retrieves financial data from the card holder dataset 425 related to those particular card holder accounts and/or additional card holder accounts as needed to populate the time-series event database/table of the master dataset 440, and stores that data at the distributed file system 430.

The distributed file system 430 uploads the data collected at the distributed file system 430 from the non-monetary dataset 420 and the card holder dataset 425 to the master dataset 440. In some cases, this is done using a bulk data loader. In some cases, only data which has changed relative to the most recent corresponding data in the master dataset 440 will be added/appended/written into the master dataset 440. For example, if a user's address is retrieved from the non-monetary dataset 420 but is the same as the most recently identified address for that user in the master dataset 440, then no new entry is added. On the other hand, if the user's address is retrieved from the non-monetary dataset 420 but is different compared to the most recently identified address for that user in the master dataset 440, then a new entry identifying the new address is appended to the master dataset 440. In some cases, entries are never deleted from the master dataset 440, so that old data, such as previous addresses of a user, can still be accessed. Entries may instead be timestamped or sorted from most recent to least recent (or vice versa) so that it is clear which entry is most recent (e.g., which address of the user is current).

Once the master dataset 440 has been updated, the master dataset 440, the distributed file system 430, another portion of the data lake system 405, or some combination thereof may identify which accounts underwent changes, and may notify the account even processor 435 of these changes. The account event processor 435 may be part of the computing system 105. The account event processor 435 may be notified of the changes to the accounts, in some cases, and may be notified via a message identifying an account number (or other identifier) of each account that underwent a change, an event time stamp associated with the change, and in some cases the event that occurred at that timestamp (e.g., change of address). In some cases, the account event processor 435 may request additional information from the master dataset 440, for instance by querying the master dataset 440 based on the account number and/or the event timestamp. In some cases, the account event processor 435 may request prior information about one or more events preceding the timestamp as well as information about the event associated with the timestamp. The response received by the account event processor 435 from the master dataset 440 may include information about the event associated with the timestamp and/or prior information about one or more events preceding the timestamp. The response received by the account event processor 435 from the master dataset 440 may include, for example, an account number, an event timestamp, a FICO® account score (or new address or other change), a CBR (or no-hit indicator), a VantageScore®, a Stripe® Radar® score, a client number (e.g., of a client terminal 190 requesting an analysis of the user associated with this account), a system number, a principle number, an agent number, or some combination thereof.

The account event processor 435 may receive rules from a rules configuration 450. The account event processor 435 may then evaluate data for the account event and/or the prior data based on the set of rules from the rules configuration 450. If one or more rules apply, the account event processor 435 transfers the corresponding account data to the account score calculator 445. Rules may include, for example, certain thresholds or ranges for values, such as for a user's age, income, bank account balance, balance due, debt balance, repaid debt balance, FICO® account score, CBR (or no-hit indication), VantageScore®, Stripe® Radar® score, other types of scores/ratings/values discussed herein, or some combination thereof. For instance, a positive/good analysis may be generated for a user (e.g., a good account score may be generated and/or the user may be approved for a loan or other program) if the user's age is within an income-earning age range, the user's income exceeds an income threshold, the user's bank account balance exceeds a bank balance threshold, the user's balance due falls below a balance due threshold, the user's debt balance falls below a debt balance threshold, the user's repaid debt balance exceeds a repaid debt balance threshold, the user's FICO® account score exceeds a FICO® account score threshold, the user's CBR exists (does not return a no-hit indication) and is from a reputable credit bureau and exceeds a CBR threshold, the user's VantageScore® exceeds a VantageScore® threshold, the user's Stripe® Radar® score exceeds a Stripe® Radar® score threshold, or some combination thereof. Similarly, a poor/negative analysis may be generated for a user (e.g., a low account score may be generated and/or the user may be declined for a loan or other program and/or the user's account may be frozen) if the user's age falls outside of an income-earning age range, the user's income falls below an income threshold, the user's bank account balance falls below a bank balance threshold, the user's balance due exceeds a balance due threshold, the user's debt balance exceeds a debt balance threshold, the user's repaid debt balance falls below a repaid debt balance threshold, the user's FICO® account score falls below a FICO® account score threshold, the user's CBR exists (does not return a no-hit indication) and is from a reputable bureau and falls below a rating threshold, the user's VantageScore® falls below a VantageScore® threshold, the user's Stripe® Radar® score falls below a Stripe® Radar® score threshold, or some combination thereof.

In some cases, rules make take into account prior data over a time period, such as gradual changes to a FICO® account score over time that together add/sum up to a large change exceeding or falling below a threshold, or that have an average slope or trajectory over the period of time (e.g., when graphed) that exceeds or falls below a threshold. In some cases, rules may have exceptions, in which case a value exceeding or falling below a threshold may not have the effect it normally would have due to a certain characteristic of the user, an account, a country and/or local laws, or some combination thereof. In some cases, triggering of certain rules may result in output of reason codes associated with those rules. For instance, if a user's loan is declined primarily because their FICO® account score falls below a threshold, the analysis may include a reason code, which may be a number of a string of characters, and that can correspond to “low FICO® account score” if looked up in a look-up table. Some rules may check for errors in data, for example by checking if a value is within a valid range, and not considering the value within the final analysis of the user if the value is outside of the valid range (or in an invalid range). For example, if the user's age is zero, or is negative, then the error-checking rule can indicate that there is likely an error in the user's age data, and the age should not be considered in the analysis. The account data transferred from the account event processor 435 to the account score calculator 445 may include any of the data discussed above as having been received by the account event processor 435, such as the account number, a new account score (or address or other change), and/or an event timestamp. In some examples, the rules of the rules configuration 450 of FIG. 4 may include the rules of the rules engine of FIG. 1, rules of the rules engine (block 235), the user-based rules 850 of FIGS. 8-9, the transaction-based rules 855 of FIGS. 8-9, the fraud detection rules 860 of FIGS. 8-9, or a combination thereof.

The account score calculator 445 receives the account information from the account event processor 435 and in some cases requests additional data from the master dataset 440. The request may include, for example account number and event timestamp. The additional data received at the account score calculator 445 from the master dataset 440 may include, for example, any information previously discussed as added to the master dataset 440 or as sent from the master dataset 440 to the account even processor 435, as well as an account number, a client number, a system number, a principle number, an agent number, a behavior score, an external status, a current balance, an existing credit, or some combination thereof. In some cases, the account score calculator 445 may interface with the master dataset 440 through a data reading application programming interface (API) and/or a data security (DS) service such as a firewall or data tokenization service.

The account score calculator 445 calculates an account score for the account, or updates/recalculates the account score for the account if a previous account score was already calculated and retrieved from the master dataset 440, in real-time (or near real-time) as the system receives data and/or waits to receive data (e.g., the first dataset, the second dataset, and/or other responsive datasets) (e.g., constantly and/or continuously) and/or as the system calculates other scores. The account score generated by the account score calculator 445 is distinct from an account score such as the FICO® account score or similar score in that it may take into account a variety of data sources, including FICO® account score data, CBR data (or no-hit indicator), VantageScore® data, Stripe® Radar® score data, transaction data, non-monetary data, or combinations thereof. In some cases, this account score may serve as the analysis of the user in operation 340 of FIG. 3.

The account score calculator 445 may transfer the updated/recalculated account score and/or additional information to the master dataset 440 directly in some cases, and the master dataset 440 may store the updated/recalculated account score and/or the additional information. The account score calculator 445 may alternately or additionally transfer the updated/recalculated account score and/or the additional information to a data storage system 460, in some cases after being modified through an aggregation/formatting/configuration service 455. In some cases, the updated/recalculated account score and/or the additional information may be transferred to the data storage system 460 using an Apache® Spark™ job and/or an Apache® Kafka® topic. The data lake system 405 may retrieve data from the data storage system 460 to populate the non-monetary dataset 420 and/or the card holder dataset 425, and the cycle may continue. In some cases, the additional information transferred along with the updated/recalculated account score by the account score calculator 445 may include an account number, some non-monetary information, various flags detailing status or properties of an account or user, nonce/filler data (e.g., a number of bytes), a terminal/device identifier, an operator code (e.g., AM).

FIG. 5 is a block diagram illustrating techniques and technologies for self-healing micro-services.

The block diagram 500 of FIG. 5 illustrates self-healing micro-service operations. The operations may, in some cases, start at micro-service 505, as indicated by the dashed “start” block.

Block 205) represents a micro-service. As a time-sensitive micro-service may require data from a data source, the micro-service 505 sends a request 510 for data to the control logic module 515. The control logic module 515 may be an independent code component of the micro-service 505.

The control logic module 515 may request and receive data from one or more data sources via one or more communications 520. In particular, two data sources are illustrated—a data source 1 525A and a data source 2 525B. The one or more communications 520 include requests for data that the control logic module 515 sends to the data source 1 525A and the data source 2 525B in parallel. The one or more communications 520 may include data received by the control logic module 515 from the data source 1 525A and the data source 2 525B. The data from the data source 1 525A and the data source 2 525B may be received asynchronously by the control logic module 515 rather than simultaneously. The number of data sources 525 may depend on the level of resiliency that the system requires to meet a specified business risk tolerance.

The control logic module 515 may retrieve and execute control logic 535 at an operation 530 to set one or more preference timers to allow one of the data sources 525 preferential treatment in some cases. For example, if a preference for data source 1 525A is desired, then a 100 millisecond (ms) preference timer may be set by the control logic module 515 according to the control logic 535, the preference timer indicating that the control logic module 515 should wait 100 ms for all data to be retrieved. If the data source 1 525A responds within that time, the control logic module 515 should use data source 1 525A as a basis for generating its analysis of the user in real-time (or near real-time) as the system receives data (e.g., from the data source 1 525A and/or the data source 2 525B and/or other data sources) (e.g., constantly and/or continuously) and/or waits to receive data (e.g., from the data source 1 525A and/or the data source 2 525B and/or other data sources). If data source 1 525 does not respond within 100 ms, then the control logic module 515 should instead use data from data source 2 525B as a basis for generating its analysis of the user.

The control logic module 515, executing the control logic 535, can also detect chronic latency from data sources 525 and adjust the control logic module 515's behavior accordingly. For example, if the preferred data source's response exceeds the retrieval timer X number of times within a configured window, the control logic module 515 may change its the preferred data source to be a different data source, as the previously-preferred data source is unreliable.

The situational awareness service 545 is a service that may also feed information 540 to the control logic module 515, and by extension is utilized by the control logic 535. The situational awareness service 545 reports on the condition of the data sources. For example, the situational awareness service 545 may identify whether data sources 525 are synchronized with one another (e.g., yes or no), what the computational/time cost is of one data source over another, what the quality is of one data source over another, or some combination thereof. The information 540 from the situational awareness service 545 may be used by the control logic module 515 and the control logic 535 to determine whether to prefer one data source 525 over another, and if so, which data source 525 to prefer.

A concluding data message 550 is sent back to the micro-service 505 by the control logic module 515 and/or the control logic 535. The concluding data message 550 may include data from one or more of the data source(s) 525, and may include preference information as to which data to prefer. Alternately, if information from one of the data sources 525 is preferred, information from other data sources may be excluded from the final data message 550.

FIG. 6 is a system architecture block diagram for a data lake system for self-healing micro-services.

A service 605, which may be a micro-service 505 as in FIG. 5 or a service in the domain services layer 120 of FIG. 1, may send a request for information to a data lake system 630 and to a second data source 625. These requests may be sent in parallel or sequentially in either order. The data lake system 630 may include a primary data source 620 that may be a higher priority data source than the second data source 625, for instance because it is a more direct and/or reputable source (e.g., it is provided by an organization that is an authority on or original source of this type of data), a more verifiable data source, a more secure data source, a more up-to-date source of data, or some combination thereof. The second data source 625 may include data that has been backed up from the primary data source 620 periodically, but may be less up-to-date, direct, reputable, verifiable, and/or secure due to it being a backup rather than straight from the organization that is considered an authority on or original source of this type of data. For instance, the data lake system 630 may provide a FICO® score straight from an agency, while the second data source 625 may provide a backup of a FICO® score that was received relatively recently from the agency.

The data lake system 630 may receive the request through a data security layer 610, which may include a firewall and/or a data tokenization system. A data lake application programming interface (API) 615 may be used to submit the request to a primary data source 620 in the data lake system 630. In some cases, the primary data source 620 in the data lake system 630 may respond to the service 605 with information responsive to the request. In some cases, the primary data source 620 in the data lake system 630 may perform a one-way replication of at least a subset of its data (e.g., the data corresponding to that request and/or response) by sending that data to a second data source 625, which may in some cases be located in a different location than the primary data source 620 so as to provide a safe backup in case of natural disaster or simple network latency.

If the service 605 receives a response from the primary data source 620 within an amount of time necessary (e.g., before the timer of the process 300 expires), then the service 605 may use the data from the primary data source 620 to generate an analysis. If the service 605 does not receive a response from the primary data source 620 of the data lake system 630 within the amount of time necessary (e.g., before the timer of the process 300 expires) for one reason or another (e.g., server downtime, natural disaster, etc.), the service 605 may instead use data received by the service 605 from the second data source 625. In this way, relatively up-to-date data may be provided in a timely fashion even if the primary data source is slow or sometimes unreliable. If the primary data source 620 becomes regularly slow or unreliable, then the secondary data source 625 can become a primary data source 620, and the primary data source 620 can be demoted to second data source 625 status.

In some cases, the request to the second data source 625 is sent directly from the service 605 to the second data source 625. In other cases, the request to the second data source 625 is sent from the service 605 to at least part of the data lake system 630, such as the data lake API 615, which may then forward the request on to the second data source 625 if the primary data source 620 is not responsive. In this way, the service 605 needs only to send one request to the data lake system 630, simplifying its work, and the data lake system 630 may handle further forwarding of the request to the primary data source 620 and the second data source 625. In some cases, requests may be sent from the service 605 and/or the data late system 630 to a third data source, fourth data source, or even more data sources to increase the odds that at least one of the data sources will be up and able to provide the requested data within the time allotted (e.g. before the timer expires).

FIG. 7 is a flow diagram illustrating a process 700 for dynamic timed decisioning. The process 700 of FIG. 7 are performed by a dynamic time-dependent asynchronous analysis system. The dynamic time-dependent asynchronous analysis system may be, and/or may include, the computing system 105 of FIG. 1, the data lake system 130 of FIG. 1, the user analysis and decisioning system of FIG. 2, the dynamic time-dependent asynchronous analysis system of FIG. 3, the data lake system of FIG. 4, the user analysis and decisioning system of FIG. 5, the data latke system of FIG. 6, the user analysis and decisioning system 800 of FIG. 8, the user analysis and decisioning system 900 of FIG. 9, the dynamic time-dependent analysis system of FIG. 10, the ML engine 1120, the ML model(s) 1125, the ML model(s) 1225, the computing system 1300 of FIG. 13, or a combination thereof.

At operation 705, the dynamic time-dependent asynchronous analysis system receives, from a client terminal, a request for an analysis of a user. The client terminal can include, for example, the client terminal 190 of FIG. 1, the requesting node (block 205) of FIG. 2, the terminal of operation 305 and 345, a user device associated with the user, a merchant device associated with a merchant, a financial institution device associated with a financial institution, a credit institution device associated with a credit institution, or a combination thereof. The request for the analysis of the user may be received based on the user requesting a transaction, such as one or more purchases by the user from the entity, rentals by the user from the entity, applications for credit (e.g., for a new line, a new loan, a new card) by the user from the entity, changes to credit (e.g., requesting a limit increase or other adjustment to a line) by the user from the entity, or a combination thereof. Operations 305 and/or 920 may be examples of operation 705, and vice versa.

At operation 710, the dynamic time-dependent asynchronous analysis system determines a duration of time available for responding to the request. In some examples, the request for the analysis of the user may itself identify the duration of time available for responding to the request, or may be sent along with other data identifying the duration of time available for responding to the request, in which case determines the duration of time may include parsing the duration of time from the request for the analysis of the user or from the other data identifying the duration of time.

At operation 715, the dynamic time-dependent asynchronous analysis system starts a timer in response to receiving the request. The timer may be the timer of FIG. 2 and/or the timer of FIG. 3. The timer may start from the time of receipt of the request for the analysis of the user. The timer may start from the time of transmission of the request for the analysis of the user. The timer may start a time at which one of the operations 705-735 occurs, begins, or completes. Operation 310 may be an example of operation 715, or vice versa.

At operation 720, the dynamic time-dependent asynchronous analysis system transmits a plurality of requests for information about the user to one or more data sources. The plurality of requests for information can include at least a first request and a second request. In some cases, the requests may be referred to as queries, and transmitting the requests may be referred to as querying a data source. The one or more communications 270 to the various data services (block 275) of FIG. 2 may be examples of the plurality of requests for information about the user transmitted to the one or more data sources of operation 720. The one or more communications 520 sent to the data source 1 525A and/or the data source 2 525B of FIG. 5 may be examples of the plurality of requests for information about the user transmitted to the one or more data sources of operation 720. The one or more requests sent from the service 605 of FIG. 6 may be examples of the plurality of requests for information about the user transmitted to the one or more data sources of operation 720. Examples of the one or more data sources may include the various data services (block 275), the data lake system 405, the master dataset 440, the account score calculator 445, the data storage system 460, the non-monetary dataset 420, the card holder dataset 425, the distributed file system 430, the data source 1 525A, the data source 2 525B, the primary data source 620, the second data source 625, the data lake system 630, the data lake 930, or a combination thereof. Operation 315 may be an example of operation 720, or vice versa.

In some examples, transmitting the plurality of requests in operation 720 includes transmitting the first request in parallel with transmitting the second request. In some examples, transmitting the plurality of requests in operation 720 includes transmitting the first request before transmitting the second request. In some examples, transmitting the plurality of requests in operation 720 includes transmitting the first request after transmitting the second request

At operation 725, the dynamic time-dependent asynchronous analysis system receives a first responsive dataset from the one or more data sources in response to transmission of the first request. The one or more communications 270 from the various data services (block 275) of FIG. 2 may be examples of responsive datasets such as the first responsive dataset. The one or more communications 520 received from the data source 1 525A and/or the data source 2 525B of FIG. 5 may be examples of the first responsive dataset from the one or more data sources of operation 725. The first dataset of operation 320 may be an example of the first responsive dataset of operation 725, or vice versa. Operation 320 may be an example of operation 725, or vice versa.

At operation 730, the dynamic time-dependent asynchronous analysis system determines, based on time still remaining on the timer following receipt of the first responsive dataset and on the duration of time available for responding to the request, that an optimal action for generating the analysis includes waiting for receipt of a second responsive dataset in response to transmission of the second request. The timer may count up or down, and may count as “expired” when the timer has counted a threshold duration of time that is based on the duration of time available for responding to the request. The dynamic time-dependent asynchronous analysis system can determine the optimal action in real-time (or near real-time) as the dynamic time-dependent asynchronous analysis system receives data (e.g., the first and/or second responsive dataset(s) and/or other dataset(s)) (e.g., constantly and/or continuously) and/or waits to receive data. Decision point 245 may be an example of operation 730, or vice versa. Operation 325 may be an example of operation 720, or vice versa.

The determination that the optimal action for generating the analysis includes waiting for receipt of a second responsive dataset may be based on a determination that the second responsive dataset includes, is set to include, or is likely to include, information that is important to generate the analysis of the user (e.g., an account score of the user). The determination that the optimal action for generating the analysis includes waiting for receipt of a second responsive dataset may be based on an estimated time of receipt of the second responsive dataset being soon, for instance before the timer counts the threshold duration of time. The determination that the optimal action for generating the analysis includes waiting for receipt of a second responsive dataset may be based on the second responsive dataset already undergoing receipt operations at the dynamic time-dependent asynchronous analysis system at the time of the determination of the optimal action. The determination that the optimal action for generating the analysis includes waiting for receipt of a second responsive dataset may be based on the second responsive dataset being a cached copy (e.g., replicated in the second data source 625) of information that would otherwise be in a third responsive dataset (e.g., from a primary data source 620), where an estimated time of receipt of the third responsive dataset is after the timer counts the threshold duration of time.

In some examples, the optimal action determined in operation 730 includes transmitting the second request of operation 720.

At operation 735, the dynamic time-dependent asynchronous analysis system receives the second responsive dataset from the one or more data sources in response to transmission of the second request. The one or more communications 270 from the various data services (block 275) of FIG. 2 may be examples of responsive datasets such as the second responsive dataset. The one or more communications 520 received from the data source 1 525A and/or the data source 2 525B of FIG. 5 may be examples of the second responsive dataset from the one or more data sources. The second dataset of operation 330 may be an example of the second responsive dataset of operation 735, or vice versa. Operation 330 may be an example of operation 735, or vice versa.

The receipt of the second responsive dataset in operation 735 may be based on the determination, in operation 730, that the optimal action for generating the analysis includes waiting for receipt of the second responsive dataset. For instance, the receipt of the second responsive dataset in operation 735 may be the result of waiting for receipt of the second responsive dataset.

In some examples, receipt of the first responsive dataset occurs at a first time, and receipt of the second responsive dataset occurs at a second time. The second time may be after the first time. The second time may be contemporaneous with the first time.

At operation 740, the dynamic time-dependent asynchronous analysis system determines, following receipt of the second responsive dataset, that the timer has counted at least a threshold duration of time. The threshold duration of time is based on the time available for responding to the request. The timer may count up or down, and may count as “expired” when the timer has counted a threshold duration of time that is based on the duration of time available for responding to the request. In some examples, the threshold time is a less than the duration of time available for responding to the request by a difference, with the difference being an amount of time within which the analysis can be generated and sent. Decision point 245 may be an example of operation 740, or vice versa. Operation 340 may be an example of operation 740, or vice versa.

In some examples, the threshold duration of time is the duration of time available for responding to the request minus a predetermined analysis duration of time. The predetermined analysis duration of time can be a predetermined amount of time for generating and/or sending the analysis as in operations 745 and/or 750. In some examples, the threshold duration of time is a predetermined percentage of the duration of time available for responding to the request. A remaining percentage of the duration of time available for responding to the request can be an analysis duration of time for generating and/or sending the analysis as in operations 745 and/or 750.

At operation 745, the dynamic time-dependent asynchronous analysis system generates the analysis of the user based on the first responsive dataset and the second responsive dataset based on the timer having counted at least the threshold duration of time. The account score generated by the account score calculator 445 may be an example of the analysis of operation 745. The dynamic time-dependent asynchronous analysis system can generate the analysis in real-time (or near real-time) as the dynamic time-dependent asynchronous analysis system receives the second dataset (and/or other dataset(s), and/or as the dependent asynchronous analysis system generates other analyses about other client(s) and/or account(s)). The analysis generated at the generate analysis 870 operation of FIGS. 8 and/or 9 may be examples of the analysis of operation 745. The decision generated at the decisioning 875 operation of FIGS. 8 and/or 9 be examples of the analysis of operation 745. Operation 335 may be an example of operation 745, or vice versa.

At operation 750, the dynamic time-dependent asynchronous analysis system transmits the analysis of the user to the client terminal based on timer having counted at least the threshold duration of time. The transmission of the analysis and/or decision operation 950 of FIG. 9 may be an example of the transmission of the analysis of the user to the client terminal of operation 750. Operation 345 may be an example of operation 750, or vice versa.

In some examples generating the analysis in operation 745 includes generating a score corresponding to a level of risk associated with the user. The score can be within a range of possible scores. The score corresponding to the level of risk associated with the user can correspond to an account worthiness of the user. For example, the score corresponding to the level of risk associated with the user can be the account score generated by the account score calculator 445 of FIG. 4. The analysis generated in operation 745 can include the score corresponding to the level of risk associated with the user.

In some examples, the dynamic time-dependent asynchronous analysis system determines that the score exceeds a predetermined score threshold, and the analysis includes a recommendation based on determining that the score exceeds the predetermined score threshold. The recommendation can be a recommendation to approve the user for at least one of a new credit account or a limit increase based on determining that the score exceeds the predetermined score threshold. In some examples, the dynamic time-dependent asynchronous analysis system determines that the score is less than a predetermined score threshold, and the analysis includes a recommendation based on determining that the score is less than the predetermined score threshold. The recommendation can be a recommendation to decline the user for at least one of a new credit account or a limit increase.

In some examples, the dynamic time-dependent asynchronous analysis system receives a third responsive dataset from the one or more data sources in response to transmission of a third request and after the timer has counted at least the threshold duration of time. The plurality of requests for information include the third request The one or more communications 270 from the various data services (block 275) of FIG. 2 may be examples of responsive datasets such as the third responsive dataset. The one or more communications 520 received from the data source 1 525A and/or the data source 2 525B of FIG. 5 may be examples of the third responsive dataset from the one or more data sources. In some examples, the analysis is generated without use of the third responsive dataset in response to receipt of the third responsive dataset after the timer has counted at least the threshold duration of time.

In some examples, the dynamic time-dependent asynchronous analysis system receives a third responsive dataset from the one or more data sources in response to transmission of a third request and b the timer has counted at least the threshold duration of time. The plurality of requests for information include the third request The one or more communications 270 from the various data services (block 275) of FIG. 2 may be examples of responsive datasets such as the third responsive dataset. The one or more communications 520 received from the data source 1 525A and/or the data source 2 525B of FIG. 5 may be examples of the third responsive dataset from the one or more data sources. In some examples, the analysis is generated based also on the third responsive dataset in response to receipt of the third responsive dataset before the timer has counted at least the threshold duration of time.

In some examples, the first responsive dataset and the second responsive dataset are part of a plurality of responsive datasets. The plurality of responsive datasets can include a Fair Isaac Corporation (FICO)® score. The analysis generated in operation 745 may be generated based on the FICO® score.

In some examples, the first responsive dataset and the second responsive dataset are part of a plurality of responsive datasets. The plurality of responsive datasets can identify, include, or be indicative of a change in a property of the user. The analysis generated in operation 745 may be generated based on the change in the property of the user. The change in the property of the user may include at least one of a change in a marriage status of the user, a change in an employment status of the user, a change in a dependent status of the user, a change in an address of the user, a change in a name of the user (e.g., a change in a surname due to marriage or other reasons), or a combination thereof.

In some examples, the first responsive dataset and the second responsive dataset are part of a plurality of responsive datasets. The plurality of responsive datasets can identify, include, or be indicative of a plurality of changes in a parameter associated with the user over an assessed period of time. The analysis generated in operation 745 may be generated based on the plurality of changes in the parameter associated with the user over the assessed period of time. Examples of this assessing of a parameter over a period of time are discussed herein with respect to the data lake system 405, the account event processor 435, the rules configuration 450, and/or the account score calculator 445 of FIG. 4. In some examples, the dynamic time-dependent asynchronous analysis system determines a trajectory of values for the parameter over the assessed period of time based on the plurality of changes in the parameter over the assessed period of time, and the analysis is generated based on the trajectory of values for the parameter over the assessed period of time. Examples of this assessing a trajectory of a parameter over a period of time are discussed herein with respect to the data lake system 405, the account event processor 435, the rules configuration 450, and/or the account score calculator 445 of FIG. 4. In some examples, the dynamic time-dependent asynchronous analysis system determines a sum of the plurality of changes in the parameter associated with the user over the assessed period of time, wherein the analysis is generated based on a comparison between the sum and a threshold value. Examples of this assessing of a parameter based on a sum over a period of time are discussed herein with respect to the data lake system 405, the account event processor 435, the rules configuration 450, and/or the account score calculator 445 of FIG. 4.

In some examples, the dynamic time-dependent asynchronous analysis system generates the analysis of the user based on a set of rules. The set of rules can include, for example, the rules of the rules engine of FIG. 1, the rules of the rules engine (block 235), the rules of the rules configuration 450 of FIG. 4, the user-based rules 850 of FIGS. 8-9, the transaction-based rules 855 of FIGS. 8-9, the fraud detection rules 860 of FIGS. 8-9, or a combination thereof. The dynamic time-dependent asynchronous analysis system can apply the set of rules, for example by comparing thresholds and/or ranges identified in the set of rules to information in the first responsive dataset, information in the second responsive dataset, information in a third responsive dataset, or a combination thereof.

In some examples, the dynamic time-dependent asynchronous analysis system performs a combination of one or more operations illustrated in or discussed with respect to in FIG. 1, one or more operations illustrated in or discussed with respect to in FIG. 2, one or more operations illustrated in or discussed with respect to the process 300 of FIG. 3, one or more operations illustrated in or discussed with respect to FIG. 4, one or more operations illustrated in or discussed with respect to FIG. 5, one or more operations illustrated in or discussed with respect to FIG. 6, one or more operations illustrated in or discussed with respect to the process 700 of FIG. 7, one or more operations illustrated in or discussed with respect to FIG. 8, one or more operations illustrated in or discussed with respect to FIG. 9, one or more operations illustrated in or discussed with respect to FIG. 13, or a combination thereof.

Technical improvements provided by a dynamic time-dependent asynchronous analysis system as described herein may include, for example, improved efficiency in generating and providing an analysis, for example based on determination of optimal actions for generating the analysis (e.g., whether to wait to receive a particular dataset to use for generating an analysis based on an estimated time to receive the dataset and/or an estimated importance of the dataset to generating the analysis) within a duration of time available for responding to the request (see at least operations 705, 710, 730, 325, 335). Technical improvements also include increased reliability in providing the analysis, since the duration of time available for responding to the request is adhered to and the dynamic time-dependent asynchronous analysis system flexibly handles issues such as nonresponsive data sources without sacrificing provision of the analysis in a timely manner. The efficiency and reliability here also does not sacrifice security, as discussed herein with respect to fraud detection rules 860 for example, and allows the analysis for the analysis generated by the dynamic time-dependent asynchronous analysis system to be as thorough as possible given the duration of time available for responding to the request. Further technical improvements include increased efficiency and reliability for client devices that send the request for the analysis of the user and that receive the analysis of the user from the dynamic time-dependent asynchronous analysis system. Because these client devices can perform transactions such as providing users with cards or lines of credit, the technical improvements to the dynamic time-dependent asynchronous analysis system mean improvements to the efficiency and reliability of systems for provision of cards, lines of credit, or other transactions.

FIG. 8 is a block diagram illustrating a system architecture of a user analysis and decisioning system 800 with an analysis engine 805, a choreography engine 815, and a strategy engine 845. The user analysis and decisioning system 800 includes an analysis engine 805. The analysis engine 805 may include one or more computing system 1300.

The user analysis and decisioning system 800 receives a request for an analysis of a user. For example, the request for the analysis of the user can be received from a merchant device of a merchant who is requesting the analysis of the user before initiating and/or completing a transaction between the merchant and the user, from an account institution device of an account institution (e.g., card processors, card issuers, bureaus, lenders, credit owners) who is requesting the analysis of the user before initiating and/or completing a transaction between the account institution and the user, from a financial institution device of a financial institution (e.g., banks, credit unions, lenders) who is requesting the analysis of the user before initiating and/or completing a transaction between the financial institution and the user. Examples of transactions between the user and an entity (e.g., a merchant, an account institution, or a financial institution) with may include purchases by the user from the entity, rentals by the user from the entity, applications for credit (e.g., for a new line, a new loan, a new card) by the user from the entity, changes to credit (e.g., requesting a limit increase or other adjustment to a line) by the user from the entity, or a combination thereof.

The analysis engine 805 initiates and/or performs a preliminary analysis 810. The preliminary analysis 810 can include various checks of information supplied as part of the request and/or as part of the transaction. The checks performed by the preliminary analysis 810 can verify whether the user is eligible and/or authorized to make the transaction. For example, the preliminary analysis 810 can verify whether the user's age meets or exceeds a threshold age required for or otherwise corresponding to the transaction, such as 13, 14, 15, 16, 17, 18, 19, 20, 21, 22, 23, 24, 25, 26, 27, 28, 29, 30, or another threshold age. The checks performed by the preliminary analysis 810 can verify whether all information required to complete the transaction is received and is in the correct format. For example, if the transaction requires or otherwise corresponds to a form to be filled out, the checks performed by the preliminary analysis 810 can verify whether all of the fields in the form are filled in, and/or can verify whether all of the fields in the form are filled in with the correct type of information, or both. For instance, the preliminary analysis 810 can verify whether a “zip code” field is filled out and includes a 5-digit number, a “name” field is filled out and includes a string of text, a “birth date” field is filled out and includes enough digits of a number to form a date, a “social security number” field is filled out and includes a 9-digit number, and so forth. The checks performed by the preliminary analysis 810 can verify whether certain action required to complete the transaction, or otherwise corresponding to the transaction, have been performed. For example, if the transaction requires the user to pay a fee, the checks performed by the preliminary analysis 810 can verify, based on a fee payment history of the user and/or a fee receipt history (e.g., of the entity), whether the user has paid the fec.

The user analysis and decisioning system 800 includes a choreography engine 815, which can perform one or more additional analyses and one or more tasks associated with the preliminary analysis 810, the strategic analysis 840, or both. The choreography engine 815 can be used, for example, to set a unique identifier 820 for each user for which an analysis is requested and/or for which data is otherwise present. The unique identifier 820 can be generated to be truly unique. Setting a unique identifier 820 and associating analyses and data with the unique identifier 820 can provide a technical benefit over use of certain identifiers such as social security number (SSN) for this purpose, as malicious parties may attempt fraudulent activities by using another person's SSN or other information. Setting of, and use of, the unique identifier 820 can prevent such fraudulent activity from affecting the actual owner of the SSN.

The choreography engine 815 can perform a duplicate check 825. The duplicate check 825 can detect whether the request for the analysis, the transaction, or both are duplicates. If so, the choreography engine 815 can discard one of the requests for analysis and/or one of the transactions. For example, the duplicate check 825 can check whether more than one identical (or very similar with only minor differences such as metadata) credit line applications for a user have been received, and/or whether more than one identical (or very similar with only minor differences such as metadata) requests for analysis of the same user corresponding to the credit line applications have been received. Such duplicates may have been submitted erroneously, and discarding one or more so that only one is left can ensure that, for example, the entity does not open two or more lines of credit for the user when the user only wished to open one line of credit. In some examples, a request for confirmation can be sent to the user and/or the entity to verify whether a duplicate can be removed, and/or whether a duplicate was intended, to allow processing of duplicate actions if they are indeed intended. The duplicate check 825 can also be used to check for certain types of fraud, such as brute force attacks by a malicious party, in which much of the information submitted for a transaction by or on behalf of the malicious party may be identical but one or more fields (e.g., password, username, SSN) may change as a malicious party attempts to find a combination of information that works.

The choreography engine 815 can include a data service 830. The data service 830 can obtain, receive, retrieve, provide, and/or transmit information about the user. In some examples, the data service 830 can be queried by the entity (e.g., by the merchant, financial institution, account institution, or any other type of entity described above) using a first set of one or more pieces of information about the user, such as the user's name, date of birth, username, password, unique identifier 820, card number, bank account number, email address, mailing address, residence address, billing address, SSN, other information about a user discussed herein, or a combination thereof. In response to the query, the data service 830 can retrieve a second set of one or more pieces of information about the user from one or more data sources, and can provide the second set of one or more pieces of information about the user to the entity. The second set of one or more pieces of information about the user can include, for example, the user's name, date of birth, username, password, unique identifier 820, card number, bank account number, email address, mailing address, residence address, billing address, SSN, other information about a user discussed herein, or a combination thereof.

The choreography engine 815 can include a bureau service 835. The bureau service 835 can communicate with one or more credit bureaus. The bureau service 835 can send an identifier of the user to a bureau device associated with a credit bureau. The identifier of the user can be, for example, the user's name, date of birth, username, password, unique identifier 820, card number, bank account number, email address, mailing address, residence address, billing address, SSN, other information about a user discussed herein, or a combination thereof. The bureau device can identify an account score for the user, and can send the account score for the user to the bureau service 835 in response to receipt of the identifier of the user at the bureau device. The bureau device can identify the account score for the user using a hard credit check, a soft credit check, or some combination thereof. In some examples, the bureau service 835 can retrieve a cached version of the account score for the user instead of, or in addition to, obtaining the account score for the user from the bureau device. For instance, hard credit checks can in some cases impact a user's account score if they are performed too often in succession, and the cached version of the account score can be retrieved and/or used if a recent credit check was performed in order to avoid impacting the user's account score further. In some cases, the cached version of the account score can be retrieved and/or used if the bureau device is not responding with the account score quickly enough (e.g., based on an amount of elapsed time since an analysis of the user was requested approaching a duration of time available for the analysis engine to generate and provide its analysis of the user). In some examples, the account score may be a FICO® account score.

The choreography engine 815 can provide any information it obtains, such as the unique identifier 820, a determination by the duplicate check 825 as to whether a request/application/transaction is a duplicate, information about the user from the data service 830, and/or account scores from the bureau service 835, to the preliminary analysis 810 and/or to the strategic analysis 840.

If the one or more checks and analyses that are part of the preliminary analysis 810 and/or choreography engine 815 successfully verify that the user is authorized to make the transaction (and/or fail to identify anything disqualifying the user from authorization to make the transaction), the analysis engine 805 can proceed to a strategic analysis 840.

If the one or more checks and analyses that are part of the preliminary analysis 810 and/or choreography engine 815 fail to verify that the user is authorized to make the transaction (and/or successfully identify something disqualifying the user from authorization to make the transaction), the analysis engine 805 can proceed to generating an analysis 870 and/or decisioning 875, with the analysis and/or decision recommending that the user be declined for the requested transaction, for instance in real-time (or near real-time) as the analysis engine 805 receives data (e.g., from the data service 830 and/or the second data source 625 via the data caching and sharing 865) and/or waits to receive data (e.g., from the data service 830 and/or the second data source 625 via the data caching and sharing 865). This way, more resource-intensive analyses, such as some of those that may be performed as part of the strategic analysis 840 and/or the strategy engine 845, can be bypassed if the preliminary analysis 810 and/or choreography engine 815 already disqualify the user.

The strategic analysis 840 can include some further fraud detection and/or fraud protection analyses. For example, the strategic analysis 840 can include a 2-factor authentication or 3-factor authentication interface, in which the user and/or entity can be required to provide an authentication code from another device, such as a mobile handset. The strategic analysis 840 can be supported by the strategy engine 845. The strategy engine 845 can include user-based rules 850, request-based rules 855, and fraud detection rules 860.

In some examples, the choreography engine 815 and the strategy engine 845 can be coupled using data caching and sharing 865. For instance, the chorography engine 815 can share information with the strategy engine 845 by sending the information to the strategy engine 845 and/or by caching the information in a data structure accessible to the strategy engine 845. In some cases, the strategy engine 845 can share information with the choreography engine 815 by sending the information to the choreography engine 815 and/or by caching the information in a data structure accessible to the choreography engine 815. In some examples, caching the information may be performed using replication of data in a data source, for instance as in the one-way replication of data from the primary data source 620 to the second data source 625 of FIG. 6.

The user-based rules 850 are related to the user themselves. Examples of the user-based rules 850 include checking whether the user is bankrupt or not, whether the user was recently bankrupt or not, whether the user is deceased or living, whether the user's file has been frozen, whether queries for information about the user result in errors or “no hit” responses, whether the user's account score exceeds a particular threshold or not, whether a slope of a trajectory the user's account score over time exceeds a particular threshold or not, which age group the user's age falls into, whether the user's aggregate credit limit (e.g., over one or more cards and/or lines of credit) exceeds a threshold, whether the number cards and/or lines of credit that the user has exceeds a threshold, whether the number cards that the user has and that are associated with a particular brand or merchant exceeds a threshold, other rules related to the user themselves, or a combination thereof.

The request-based rules 855 are related to the transaction that is being requested. For instance, if the transaction is that the user is applying for a card, the request-based rules 855 may be rules associated with eligibility for that particular card and/or related cards. Examples of the request-based rules 855 may include indications that, if a user does not meet certain requirements (e.g., an account score threshold), a different card may be offered to the user instead of the one requested. For example, if the user is applying for a dual card (DC) but is not eligible, then a private label card (PLCC) may be offered in place of the dual card. This offering of a different card or other product may be referred to as downselling. If the transaction is that the user is applying for a line of credit, the request-based rules 855 may be rules associated with eligibility for that particular line and/or related lines.

The fraud detection rules 860 may be specific to detection of fraud or likely fraud attempts. The fraud detection rules 860 may automatically identify certain types of fraud, such as brute force attacks in which many similar transaction requests are submitted sequentially with small changes in an attempt by a malicious party to find a combination that works. In some examples, the fraud detection rules 860 may be used to check whether a transaction request is coming from a geographical location that would be unusual for the user to be requesting such a transaction from, for example from another country or continent than the user is in. In some examples, the fraud detection rules 860 may request fraud checks from third parties that may perform, for example, background checks on a user.

In some examples, any one of the user-based rules 850, the transaction-based rules 855, and/or the fraud detection rules 860 can include any one or more rules discussed with respect to the rules of the rules engine of FIG. 1, the rules of the rules engine (block 235), the rules of the rules configuration 450 of FIG. 4, the user-based rules 850 of FIGS. 8-9, the transaction-based rules 855 of FIGS. 8-9, the fraud detection rules 860 of FIGS. 8-9, or a combination thereof.

The information determined by the preliminary analysis 810, the choreography engine 815, the strategic analysis 840, and/or the strategy engine 845 may feed in to generating an analysis 870 of the user. The analysis of the user may include, for example, a score for the user as discussed herein. In some examples, the analysis of the user may be used in decisioning 875 to make a decision as to whether to recommend accepting or declining the transaction for the user (e.g., whether to recommend granting or declining a requested line for the user). For example, if the score exceeds a certain transaction-specific threshold (e.g., noted in the transaction-based rules 855), the decision may be to grant the transaction, and otherwise the decision may be to decline the transaction. In some examples, the analysis of the user may include a decision (e.g., as to whether to recommend accepting or declining the transaction for the user), in which case generating the analysis 870 may be part of decisioning 875.

FIG. 9 is a block diagram illustrating a system architecture of a user analysis and decisioning system 900 with a communication system 905, an analysis system 910, and a strategy system 915. The communication system 905, the analysis system 910, and the strategy system 915 may each include one or more computing systems 1300.

At operation 920, the communication system 905 receives, from a user device or a device associated with an entity (e.g., a merchant, a financial institution, and/or an account institution), a request for an analysis of the user. The request for the analysis of the user (at operation 920) may be received based on the user requesting a transaction, such as one or more purchases by the user from the entity, rentals by the user from the entity, applications for credit (e.g., for a new line, a new loan, a new card) by the user from the entity, changes to credit (e.g., requesting a limit increase or other adjustment to a line of credit) by the user from the entity, or a combination thereof. The requested analysis may take the form of a recommendation as to whether or not to approve the transaction, and/or may include information (e.g., a score for the user) based on which the entity can more efficiently decide whether or not to approve the transaction. In some cases, the request for the analysis of the user (at operation 920) can identify a duration of time available to the user analysis and decisioning system 900 to respond to the request for the analysis of the user (at operation 920) (e.g., with the requested analysis of the user).

In response to the request for the analysis of the user (at operation 920), the analysis system 910 can perform the preliminary analysis 810. The preliminary analysis 810 can include use of the choreography engine 815. The choreography engine 815 can be on the analysis system 910, on the strategy system 915, or partially on both. As discussed with respect to FIG. 8, the choreography engine 815 can set a unique identifier 820 for the user, perform the duplicate check 825, retrieve data as a data service 830, and communicate with one or more bureaus as the bureau service 835. In some examples, the bureau service 835 can communicate with the one or more bureaus through a bureau communication link 925 of the communication system 905.

The analysis system 910 can also perform the strategic analysis 840. The strategic analysis 840 can include use of the strategy engine 845. The strategy engine 845 can be on the analysis system 910, on the strategy system 915, or partially on both. As discussed with respect to FIG. 8, the strategy engine 845 can include, and perform analyses based on, user-based rules 850, transaction-based rules 855, and/or fraud detection rules 860. In some examples, any one of the user-based rules 850, the transaction-based rules 855, and/or the fraud detection rules 860 can include any one or more rules discussed with respect to the rules of the rules engine of FIG. 1, the rules of the rules engine (block 235), the rules of the rules configuration 450 of FIG. 4, the user-based rules 850 of FIGS. 8-9, the transaction-based rules 855 of FIGS. 8-9, the fraud detection rules 860 of FIGS. 8-9, or a combination thereof.

In some examples, the strategy system 915 may include a machine learning (ML) engine 940 (e.g., ML engine 1120, ML model(s) 1125, and/or ML model(s) 1225). The ML engine 940 may include one or more artificial intelligence algorithms, one or more trained machine learning (ML) models trained using training data and generated based on one or more ML algorithms, one or more trained neural networks (NNs) trained using training data, or some combination thereof. The analysis system 910 can craft an ML input 935 as part of the strategic analysis 840, the strategy engine 845, and/or generation of the analysis 870. The ML input 935 may, for example, provide a predetermined set of one or more types of information about a user. For example, the ML input 935 may include the user's name, date of birth, username, password, unique identifier 820, card number, bank account number, email address, mailing address, residence address, billing address, SSN, other information about a user discussed herein, or a combination thereof. ML input 935 may include information about past analyses, requests for analyses, transactions, requests for transactions, decisions regarding those transactions, or combinations thereof. The ML engine 940 can generate an ML output 945, which the analysis system 910 can receive, parse, and/or interpret. For example, the ML engine 940 can be trained to estimate a user's eligibility for a transaction as its ML output 945 based on the ML input 935. Such training can be done based on training data with eligibility decisions for multiple users for the transactions of the same type alongside similar input information. The ML engine 940 can be trained to identify fraudulent activity as its ML output 945 based on the ML input 935. Such training can be done based on training data within which activities are tagged as fraudulent or not based on similar input information. The ML engine 940 can be trained to estimate an analysis 870 as its ML output 945 based on the ML input 935. Such training can be done based on training data within which analyses are identified based on similar input information.

The choreography engine 815 and the strategy engine 845 can share information through data caching and sharing 865 as discussed with respect to FIG. 8. The strategy system 915 may include a data lake 930, which may include aspects of the data lake systems of FIGS. 4 and/or 6. The data lake 930 can be accessed by, and/or interacted with, by the choreography engine 815 and/or the strategy engine 845.

The analysis system 910 can generate the analysis 870. The information determined by the preliminary analysis 810, the choreography engine 815, the strategic analysis 840, and/or the strategy engine 845 may feed in to generating an analysis 870 of the user. The information from the ML output 945 and/or the data lake 930 can feed in to generating an analysis 870 of the user. The analysis of the user may include, for example, a score for the user as discussed herein. In some examples, the analysis of the user may be used in decisioning 875 to make a decision as to whether to recommend accepting or declining the transaction for the user (e.g., whether to recommend granting or declining a requested line of credit for the user). For example, if the score exceeds a certain transaction-specific threshold (e.g., noted in the transaction-based rules 855), the decision may be to grant the transaction, and otherwise the decision may be to decline the transaction. Decisioning 875 may occur on the analysis system 910, the communication system 905 (e.g., which may perform decisioning 875 with a merchant device, financial institution device, or account institution device), or a combination thereof. In some examples, the analysis of the user may include a decision (e.g., as to whether to recommend accepting or declining the transaction for the user), in which case generating the analysis 870 may be part of decisioning 875. At operation 950, the communication system 905 may transmit the analysis and/or the decision to one or more recipient devices, such as a user device associated with the user, a merchant device associated with a merchant, a financial institution device associated with a financial institution, an account institution device associated with an account institution, or a combination thereof.

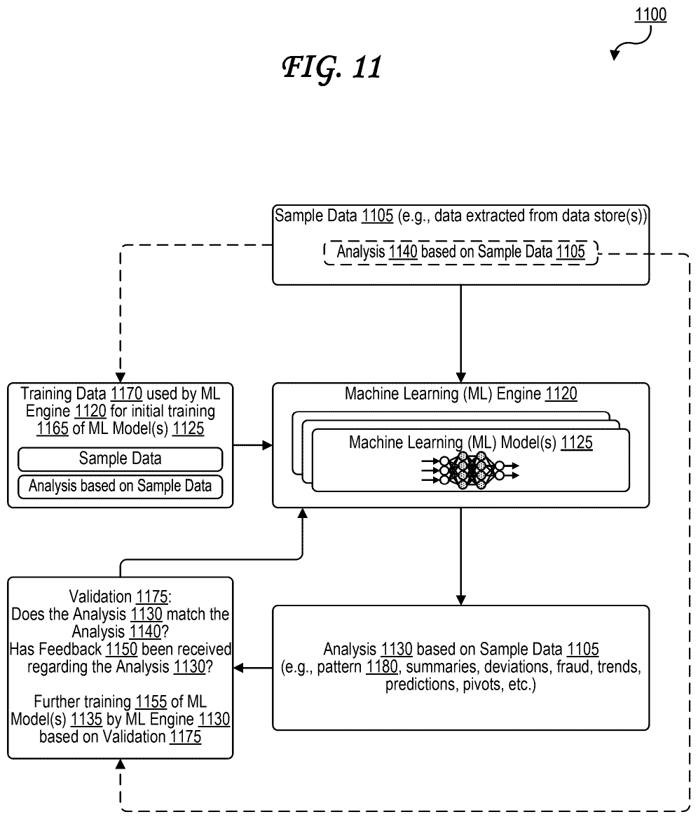

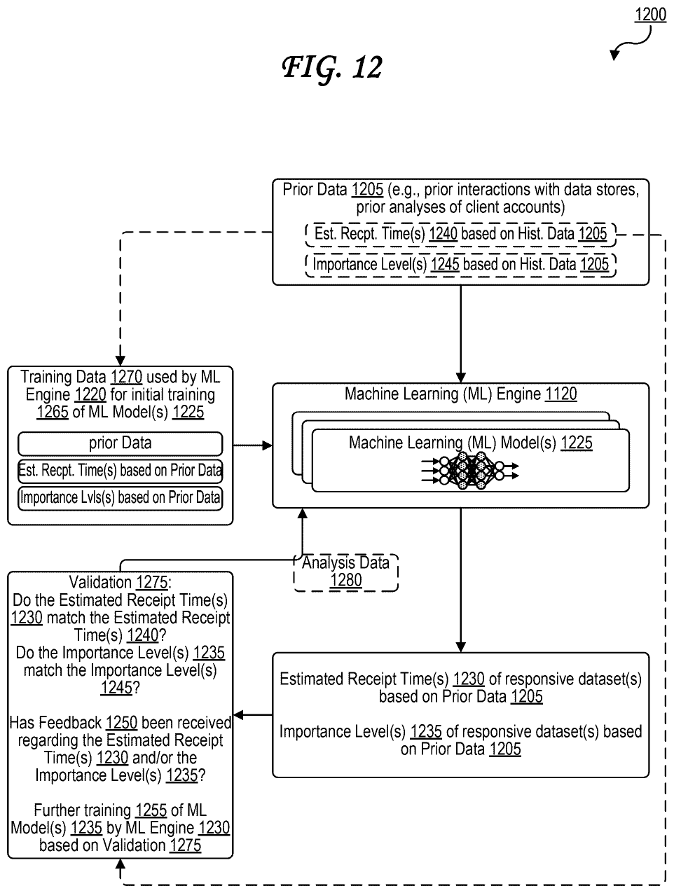

FIG. 10 is a flow diagram illustrating a process 1000 for dynamic time-dependent asynchronous analysis. The process 1000 of FIG. 10 is performed by a dynamic time-dependent asynchronous analysis system. The dynamic time-dependent asynchronous analysis system may be, and/or may include, the computing system 105 of FIG. 1, the data lake system 130 of FIG. 1, the user asynchronous analysis and decisioning system of FIG. 2, the dynamic time-dependent asynchronous analysis system of FIG. 3, the data lake system of FIG. 4, the user asynchronous analysis and decisioning system of FIG. 5, the data latke system of FIG. 6, the dynamic time-dependent asynchronous analysis system of FIG. 7, the user asynchronous analysis and decisioning system 800 of FIG. 8, the user asynchronous analysis and decisioning system 900 of FIG. 9, the machine learning engine 1120 of FIGS. 11-12, the machine learning model(s) 1125, the machine learning model(s) 1225, the computing system 1300 of FIG. 13, or a combination thereof.

At operation 1005, the dynamic time-dependent asynchronous analysis system is configured to, and can, determine, based on a time of receipt of a request, an amount of time available for responding to the request with an eligibility of the client account for a modification to the client account based on a confidence score determined for the client account. Operation 1005 can correspond to operations 305, 310, 705, 710, 715, or a combination thereof, or vice versa.

At operation 1010, the dynamic time-dependent asynchronous analysis system is configured to, and can, transmit a first query and a second query for information about client associated with the client account. Operation 1010 can correspond to communications 270, operations 315-320, communications 520, the requests of FIG. 6, operations 720-725, or a combination thereof, or vice versa.

In some examples, transmitting the first query and the second query (as in operation 1010) includes transmitting the first query in parallel with (e.g., at the same time, synchronously, simultaneously, concurrently, and/or contemporaneously) transmitting the second query. In some examples, transmitting the first query and the second query (as in operation 1010) includes transmitting the first query and the second query serially (e.g., asynchronously), for instance by transmitting the first query before the second query or by transmitting the first query after the second query.

At operation 1015, the dynamic time-dependent asynchronous analysis system is configured to, and can, generate, using at least one trained machine learning (ML) model (e.g., ML engine 940, ML engine 1120, ML model(s) 1125, ML model(s) 1225) and based on prior data store interactions (e.g., part of the prior data 1205), respective estimated times to receive a first dataset responsive to the first query and a second dataset responsive to the second query (e.g., the estimated receipt time(s) 1240). Operation 1015 can correspond to operations 325, 730, or a combination thereof, or vice versa.

At operation 1020, the dynamic time-dependent asynchronous analysis system is configured to, and can, determine, using the at least one trained machine learning model and based on prior confidence score determinations (e.g., part of the prior data 1205), respective estimated importance levels of the first dataset and the second dataset to determining the confidence score for the client account (e.g., the importance level(s) 1245). Operation 1020 can correspond to operations 325, 730, or a combination thereof, or vice versa.

In some examples, an account score (e.g., FICO® score) generated by an agency (e.g., a credit agency) is included in at least one of the first dataset or the second dataset.

In some examples, the dynamic time-dependent asynchronous analysis system is configured to, and can, determine that the first dataset is receivable from a first data store and a second data store. The dynamic time-dependent asynchronous analysis system can determine that a first estimated time to receive the first dataset from the first data store is not within the amount of time available for responding to the request (e.g., is estimated to take more time than the amount of time available for responding to the request). The dynamic time-dependent asynchronous analysis system can determine that the estimated time to receive the first dataset (determined in operation 1015) is within the amount of time available for responding to the request. The estimated time to receive the first dataset (determined in operation 1015) corresponds to receipt of the first dataset from the second data store (e.g., is the estimated time to receive the first dataset from the second data store). In some examples, the instance of the first dataset in the second data store is a backup or copy or cache or duplicate or replicate of the first dataset (e.g., a backup or copy or cache or duplicate or replicate of the instance of the first dataset stored at the first data store), as in the replication from the primary data source 620 to the second data source 625 in FIG. 6. The dynamic time-dependent asynchronous analysis system can decide to receive the first dataset from the second data store also in part based on a determination that the backup or copy or cache or duplicate or replicate of the first dataset was backed up or copied or cached or duplicated to or replicated to the second data store within a predetermined amount of time from the present (e.g., was backed up or copied to or cached or duplicated to or replicated to the second data store recently enough that the dynamic time-dependent asynchronous analysis system is confident that the instance of the first dataset that is stored in the second data store is still accurate).

At operation 1025, the dynamic time-dependent asynchronous analysis system is configured to, and can, generate a preliminary confidence score for the client (and/or the client account) based on the first dataset while waiting for receipt of the second dataset. Operation 1025 can correspond to message 220, message 240, message 280, operation 335, operation 730, operation 745, preliminary asynchronous analysis 810, strategic asynchronous analysis 840, or a combination thereof.

In some examples, generating the preliminary confidence score for the client account based on the first dataset (as in operation 1025) includes generating the preliminary confidence score using the at least one trained neural network based on input of the first dataset into the at least one trained neural network.

At operation 1030, the dynamic time-dependent asynchronous analysis system is configured to, and can, delay (e.g., wait, pause, idle, and/or perform other operations) temporarily until the second dataset is received to pause generation of the confidence score for the client (and/or client account) based on the estimated importance level of the second dataset reaching at least an importance threshold and based on the estimated time to receive the second dataset being within an amount of time for responding to a request. The dynamic time-dependent asynchronous analysis system can generate the preliminary confidence score (in operation 1025) and/or decide to pause and/or wait and/or delay (e.g., as in operation 1030 based on operations 1015 and/or 1020) in real-time (or near real-time) as the dynamic time-dependent asynchronous analysis system receives data (e.g., the first dataset and/or the second dataset and/or other dataset(s)) and/or waits to receive data (e.g., the first dataset and/or the second dataset and/or other dataset(s)) and/or generate other confidence score(s) and/or other analyses for other client(s) and/or account(s). Operation 1030 can correspond to operation 325, operation 330, operation 730, operation 735, or a combination thereof.

In some examples, the dynamic time-dependent asynchronous analysis system is configured to, and can, receive the first dataset and the second dataset from a data store. The prior data store interactions (of operation 1015) can identify at least one interaction with the data store.

In some examples, the dynamic time-dependent asynchronous analysis system is configured to, and can, receiving the first dataset from a first data store, and receive the second dataset from a second data store. The prior data store interactions (of operation 1015) can identify at least a first interaction with the first data store and at least a second interaction with the second data store.

In some examples, the dynamic time-dependent asynchronous analysis system is configured to, and can, determine that the second dataset is receivable from a first data store and a second data store. The dynamic time-dependent asynchronous analysis system can determine that a first estimated time to receive the second dataset from the first data store is not within the amount of time available for responding to the request (e.g., is estimated to take more time than the amount of time available for responding to the request). The dynamic time-dependent asynchronous analysis system can determine that the estimated time to receive the second dataset (determined in operation 1015) is within the amount of time available for responding to the request. The estimated time to receive the second dataset (determined in operation 1015) corresponds to receipt of the second dataset from the second data store (e.g., is the estimated time to receive the second dataset from the second data store). In some examples, the instance of the second dataset in the second data store is a backup or copy or cache or duplicate or replicate of the second dataset (e.g., a backup or copy or cache or duplicate or replicate of the instance of the second dataset stored at the first data store), as in the replication from the primary data source 620 to the second data source 625 in FIG. 6. The dynamic time-dependent asynchronous analysis system can decide to receive the second dataset from the second data store also in part based on a determination that the backup or copy or cache or duplicate or replicate of the second dataset was backed up or copied or cached or duplicated to or replicated to the second data store within a predetermined amount of time from the present (e.g., was backed up or copied to or cached or duplicated to or replicated to the second data store recently enough that the dynamic time-dependent asynchronous analysis system is confident that the instance of the second dataset that is stored in the second data store is still accurate).

At operation 1035, the dynamic time-dependent asynchronous analysis system is configured to, and can, update the preliminary confidence score by an update amount using the second dataset to generate the confidence score for the client account. The dynamic time-dependent asynchronous analysis system can update the preliminary confidence score to generate the confidence score in real-time (or near real-time) as the dynamic time-dependent asynchronous analysis system receives the second dataset (and/or other dataset(s)) and/or as the dynamic time-dependent asynchronous analysis system generates other analyses of other client(s) and/or account(s). Operation 1035 can correspond to message 220, message 240, message 250, message 260, message 280, message 290, operation 335, operation 745, strategic asynchronous analysis 840, asynchronous analysis 870, decisioning 875, or a combination thereof.

In some examples, the dynamic time-dependent asynchronous analysis system can receive more datasets than just the first dataset and second dataset. For example, the dynamic time-dependent asynchronous analysis system can update the preliminary confidence score to generate one or more intermediate confidence scores based on additional datasets that are received after the first dataset but before the second dataset, and can then update the one or more intermediate confidence scores based on the second dataset to ultimately generate the confidence score in operation 1035.

In some examples, updating the preliminary confidence score using the second dataset to generate the confidence score for the client account (as in operation 1035) includes generating the confidence score for the client account using the at least one trained neural network based on input of the first dataset and the second dataset into the at least one trained neural network.

In some examples, the confidence score for the client account corresponds to a worthiness (e.g., creditworthiness) of the client and/or client account, and the modification to the client account includes at least one of a new credit account, a credit limit adjustment (e.g., increase or decrease), or a new card.

At operation 1040, the dynamic time-dependent asynchronous analysis system is configured to, and can, determine an eligibility of the client account for a modification based on a comparison between the confidence score and a confidence threshold. In some examples, the confidence threshold is based on the prior confidence score determinations (e.g., based on an average, mean, median, mode, medoid, and/or weighted average of prior confidence scores for the client, for a set of multiple clients other than the client, or for a set of multiple clients that includes the client and/or similar client(s)). In some examples, the dynamic time-dependent asynchronous analysis system is configured to, and can, transmit the indication of the eligibility of the client account for the modification, for instance to a recipient device that can process the modification to the client account to put the modification into effect for the client account, and/or to a client device that can notify the client that the modification is approved and/or has been made.

At operation 1045, the dynamic time-dependent asynchronous analysis system is configured to, and can, train the at least one trained machine learning model further using training data to update the at least one trained machine learning model for at least one further client account analysis (e.g., as in the further training 1155, the further training 1255, the initial training 1165, and/or the initial training 1265), wherein the training data includes the update amount and respective times to receive the first dataset and the second dataset (e.g., the asynchronous analysis data 1280, feedback 1150, validation 1175, feedback 1250, validation 1275, training data 1170, and/or training data 1270).

In some examples, the training data (from operation 1045) also includes at least one of the preliminary confidence score or the confidence score for the client account. In some examples, the training data (from operation 1045) also includes at least one of the respective estimated times to receive the first dataset and the second dataset or the respective estimated importance levels of the first dataset and the second dataset to determining the confidence score for the client account.

In some examples, the dynamic time-dependent asynchronous analysis system is configured to, and can, transmit a third query for information about the client account. The dynamic time-dependent asynchronous analysis system can generate, using the at least one trained machine learning model and based on the prior data store interactions, an estimated time to receive a third dataset responsive to the third query. The dynamic time-dependent asynchronous analysis system can determine, using the at least one trained machine learning model and based on the prior confidence score determinations, an estimated importance level of the third dataset to determining the confidence score for the client account. In some examples, pausing temporarily until the second dataset is received (as in operation 1030) includes pausing temporarily until the third dataset is also received to delay generation of the confidence score for the client account based on the estimated importance level of the third dataset reaching at least the importance threshold and based on the estimated time to receive the second dataset being within the amount of time available for responding to the request. In some examples, updating the preliminary confidence score using the second dataset to generate the confidence score for the client account (as in operation 1035) includes updating the preliminary confidence score also using the third dataset to generate the confidence score for the client account.

In some examples, the dynamic time-dependent asynchronous analysis system is configured to, and can, transmit a third query for information about the client account. The dynamic time-dependent asynchronous analysis system can generate, using the at least one trained machine learning model and based on the prior data store interactions, an estimated time to receive a third dataset responsive to the third query. The dynamic time-dependent asynchronous analysis system can determine not to wait for receipt of the third dataset to generate the confidence score for the client account (as in operation 1035) based on the estimated time to receive the third dataset failing to be within the amount of time available for responding to the request.

In some examples, the dynamic time-dependent asynchronous analysis system is configured to, and can, transmit a third query for information about the client account. The dynamic time-dependent asynchronous analysis system can determine, using the at least one trained machine learning model and based on the prior confidence score determinations, an estimated importance level of a third dataset to determining the confidence score for the client account, where the third dataset is responsive to the third query. The dynamic time-dependent asynchronous analysis system can determine not to wait for receipt of the third dataset to generate the confidence score for the client account (as in operation 1035) based on the estimated importance level of the third dataset failing to reach at least the importance threshold.

In some examples, the dynamic time-dependent asynchronous analysis system is configured to, and can, transmit a third query for information about the client account. The dynamic time-dependent asynchronous analysis system can transmit a third query for information about the client account. The dynamic time-dependent asynchronous analysis system can generate an updated confidence score for the client account based on a third dataset after updating the preliminary confidence score for the client account to generate the confidence score for the client account (as in operation 1035). The third dataset is responsive to the third query. The dynamic time-dependent asynchronous analysis system can identify a change in the eligibility of the client account for the modification based on a comparison between the updated confidence score for the client account and the confidence threshold. The dynamic time-dependent asynchronous analysis system can transmit an indication of the change in the eligibility of the client account for the modification, for instance after transmitting the indication of the eligibility of the client account for the modification (in operation 1040). In some examples, the training data (of operation 1045) includes a second update amount indicative of a difference between the updated confidence score for the client account and the confidence score for the client account, the change in the eligibility of the client account for the modification, or a combination thereof.

In some examples, the dynamic time-dependent asynchronous analysis system generates preliminary confidence score (e.g., in operation 1025), the confidence score (e.g., in operation 1035), and/or the determination as to the eligibility of the client account for the modification (e.g., in operation 1040) based on a set of rules. The set of rules can include, for example, the rules of the rules engine of FIG. 1, the rules of the rules engine (block 235), the rules of the rules configuration 450 of FIG. 4, the user-based rules 850 of FIGS. 8-9, the transaction-based rules 855 of FIGS. 8-9, the fraud detection rules 860 of FIGS. 8-9, or a combination thereof. The dynamic time-dependent asynchronous analysis system can apply the set of rules, for example by comparing thresholds and/or ranges identified in the set of rules to information in the first responsive dataset, information in the second responsive dataset, information in a third responsive dataset, or a combination thereof. In some examples, the thresholds and ranges can be based on averages associated with prior data for the client account and/or other account(s), for instance including means, medians, modes, mediods, weighted averages, or combinations thereof.

In some examples, the dynamic time-dependent asynchronous analysis system performs a combination of one or more operations illustrated in or discussed with respect to in FIG. 1, one or more operations illustrated in or discussed with respect to in FIG. 2, one or more operations illustrated in or discussed with respect to the process 300 of FIG. 3, one or more operations illustrated in or discussed with respect to FIG. 4, one or more operations illustrated in or discussed with respect to FIG. 5, one or more operations illustrated in or discussed with respect to FIG. 6, one or more operations illustrated in or discussed with respect to the process 1000 of FIG. 10, one or more operations illustrated in or discussed with respect to FIG. 8, one or more operations illustrated in or discussed with respect to FIG. 9, one or more operations illustrated in or discussed with respect to FIG. 11, one or more operations illustrated in or discussed with respect to FIG. 12, one or more operations illustrated in or discussed with respect to FIG. 13, or a combination thereof.

Technical improvements provided by a dynamic time-dependent analysis system as described herein may include, for example, improved efficiency in generating and providing an analysis (e.g., the confidence score and/or the determination as to the eligibility of the client account for the modification), for example based on determination of optimal actions for generating the analysis within an amount of time available for responding to the request (e.g., whether to wait to use certain datasets for generating the analysis) given different estimated times to receive different datasets to be used to make the analysis and given different levels of importance of the different datasets for making the analysis. Technical improvements also include increased reliability in providing the analysis, since the duration of time available for responding to the request is adhered to and the dynamic time-dependent analysis system flexibly handles issues such as nonresponsive data sources without sacrificing provision of the analysis in a timely manner, prioritizing reliance on (and waiting for receipt of) datasets that are estimated to arrive within the amount of time available for responding to the request and datasets that have a high (e.g., exceeding a threshold) estimated level of importance to accurate analysis determination (e.g., based on prior analysis determinations, such as the prior confidence score determinations). The efficiency and reliability here also does not sacrifice security, as discussed herein with respect to fraud detection rules 860 for example, and allows the analysis for the analysis generated by the dynamic time-dependent analysis system to be as thorough as possible given the amount of time available for responding to the request, and limits the window of time in which a malicious party could feasibly be able to interfere. Further technical improvements include increased efficiency and reliability for client devices that send the request for the analysis of the user and that receive the analysis of the user from the dynamic time-dependent analysis system. Because these client devices can perform transactions such as providing users with cards or lines of credit, the technical improvements to the dynamic time-dependent asynchronous analysis system mean improvements to the efficiency and reliability of systems for provision of cards, lines of credit, modifications thereto, or other transactions.

FIG. 11 is a block diagram illustrating using one or more machine learning models 1125 of a machine learning engine 1120 to analyze data to recognize a pattern 1180. Examples of the ML engine 1120 include the AI engine 155. Examples of the ML model(s) 1125 include the ML model(s) 165. The ML engine 1120 generates, trains, and uses the ML model(s) 1125 based on an initial training 1165 using training data 11110. The ML engine 1120 trains the ML model(s) 1125 to generate an analysis 1130 on input of sample data 1105 into the ML model(s) 1125. The sample data 1105 may include data that is extracted from the data stores (e.g., by the core layer 110, the orchestration layer 115, the Domain services layer 120, the data source layer 125, the data lake system 130, the asynchronous messaging bus 1 (block 215), the control logic service (block 225), the asynchronous messaging bus 2 (block 255), the data handler service (block 265), a system that performs the process 300, the data lake system 405, the control logic module 515, the service 605, the data lake system 630, a system that performs the process 700, the analysis engine 805, the choreography engine 815, the strategy engine 845, the communication system 905, the analysis system 910, the strategy system 915, a system that performs the process 1000, and/or a computing system 1300). In some examples, the sample data 1105 may include data that is normalized, merged, and/or processed following extraction (e.g., by any of the systems listed above). In some examples, the sample data 1105 may include decisioning data, strategy data, and/or modifications (e.g., by any of the systems listed above). In some examples, the sample data 1105 may include some preliminary validation data and/or analysis data, such as summary data (e.g., by any of the systems listed above).

The analysis 1130 output by the ML model(s) 1125 can include at least one pattern 1180 identified as part of the analysis 1130 of the sample data 1105. The pattern 1180 can include any type of patterns, for instance including patterns associated with high (good) credit or confidence scores, patterns associated with low (poor) credit or confidence scores, patterns associated with fraud, patterns associated with trends, and/or patterns associated with deviations, mismatches, discrepancies, and/or disparities. In some examples, the analysis 1130 output by the ML model(s) 1125 can include various other elements of analyses described herein as output by the analysis system 910 or other systems listed above. For instance, the analysis 1130 output by the ML model(s) 1125 can include summaries, deviations, mismatches, discrepancies, disparities, fraud detections, fraud attempt detections, trends, predictions based on trends, pivots, or combinations thereof. The analysis 1130 can include a confidence score or score, or an account score or score, as discussed herein. The analysis 1130 can a determination as to an eligibility of a user/client and/or of account of the user/client for a modification to the account, for example to open a new line or modify an existing line (e.g., to increase or otherwise modify a limit or interest rate).

The training data 1110 that the ML engine 1120 uses to train the ML model(s) 1125 includes sample data (e.g., akin to the sample data 1105) as well as pre-generated assessment(s) corresponding to the sample data (e.g., akin to the analysis 1130 corresponding to the sample data 1105). Over the course of the initial training 1165, the ML model(s) 1125 develop hidden layers between input layers and output layers, and/or weights and/or connections between nodes of the various layers, that each relate to various aspects of the analysis 1130, such as any of the aspects described herein (e.g., related to various types of patterns that can be detected and characteristics of those types of patterns).

Identifying the analysis 1130 can correspond to at least the control logic service (block 225), the operation 335, the account score calculator 445, the control logic module 515, the operation 745, the strategic analysis 840, the strategy engine 845, the analysis 870, the preliminary analysis 810, the strategic analysis 840, the analysis 870, the operation 1025, the operation 1035, or a combination thereof.

Once the one or more ML models 1125 identify the analysis 1130, the analysis 1130 (and/or the indication of eligibility of the user account for the modification of operation 1040) can be output to a user (e.g., using a speaker or headphones) and/or to a recipient device that can process and/or put into effect the modification to the client account, for instance by opening a new line or modifying an existing line.

In some examples, the ML engine 1120 can continue to train and/or update the ML model(s) 1125 over time, for instance based on validation 1175 using the analysis 1130 and the sample data 1105. In some examples, an analysis 1140 of the sample data 1105 (separate from the analysis 1130 generated by the ML model(s) 1125) may be provided to the ML engine 1120 use in performing the validation 1175. In some examples, the analysis 1140 may be generated by a different entity than the ML model(s) 1125, for instance a different set of ML model(s) (not pictured) or one or more trusted human analysts. If, during validation 1115, the ML engine 1120 determines that the analysis 1130 generated by the ML model(s) 1125 matches the analysis 1140, the ML engine 1120 can treat this as positive feedback, and can perform further training 1155 of the ML model(s) 1135 based on the analysis 1130, the sample data 1105, and/or the analysis 1140, for instance to strengthen and/or reinforce weights associated with generating the analysis 1130 in the ML model(s) 1125, and/or to weaken or remove other weights other than those associated with generating the analysis 1130, in the ML model(s) 1125. If, during validation 1115, the ML engine 1120 determines that the analysis 1130 generated by the ML model(s) 1125 differs from the analysis 1140, the ML engine 1120 can treat this as negative feedback, and can perform further training 1155 of the ML model(s) 1135 based on the analysis 1130, the sample data 1105, and/or the analysis 1140, for instance to weaken and/or remove weights associated with generating the analysis 1130 in the ML model(s) 1125, and/or to strengthen and/or reinforce other weights other than those associated with generating the analysis 1130 in the ML model(s) 1125.

In some examples, the ML engine 1120 receives feedback 1150 about the analysis 1130. The feedback can include a reaction by a user of a user device via a user interface, a reaction by a user determined based on sensor data from a user device, and/or decisions by a user and/or user device as whether or not to use the analysis 1130 for a further application. Positive feedback can be used to strengthen and/or reinforce weights associated with generating the analysis 1130 in the ML model(s) 1125, and/or to weaken or remove other weights other than those associated with generating the analysis 1130 in the ML model(s) 1125. Negative feedback can be used to weaken and/or remove weights associated with generating the analysis 1130 in the ML model(s) 1125, and/or to strengthen and/or reinforce other weights other than those associated with generating the analysis 1130 in the ML model(s) 1125.

FIG. 12 is a block diagram 1200 illustrating use of one or more trained machine learning models 1225 of a machine learning engine 1120 to generate estimated receipt time(s) 1230 of datasets (e.g., as in operation 1015) and/or importance level(s) 1235 for generating a confidence score (e.g., as in operation 1020) based on prior data 1205 (e.g., prior interaction(s) with data store(s), prior confidence score(s) and/or eligibility determinations and/or other assessment(s) of client account(s). The ML engine 1120, the ML model(s) 1125, and/or the ML model(s) 1225 can include one or more neural network (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIGS. 11 and 12, a graphic representing the trained ML model(s) 1125 and the trained ML model(s) 1225 is illustrated as a set of circles connected to another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. The ML engine 1120, the ML model(s) 1125, and/or the ML model(s) 1225 can be part of any AI and/or ML modules, processes, or analysis operations discussed herein.

Once trained via initial training 1265, the one or more ML models 1225 receive, as an input, prior data 1205 that identifies prior interaction(s) with data store(s), prior confidence score(s) and/or eligibility determinations and/or other assessment(s) of client account(s). Identifying the estimated receipt time(s) 1230 and/or the importance level(s) 1235 can correspond to at least the operation 325, the operation 730, the operation 1015, the operation 1020, or a combination thereof.

Once the one or more ML models 1225 identify the estimated receipt time(s) 1230 and/or the importance level(s) 1235, the estimated receipt time(s) 1230 and/or the importance level(s) 1235 can be output to a user (e.g., by displaying the estimated receipt time(s) 1230 and/or the importance level(s) 1235 using a speaker or headphones) and/or to a recipient device that can determine whether an optimal course of action (e.g., as in operation 325 and/or 730) is to pause, wait, and or delay (e.g., as in operations 325, 730, and 1030) to receive a dataset with a level of importance (e.g., importance level(s) 1235) for generating an analysis (e.g., analysis 1130) and that is estimated to be received (e.g., per estimated receipt time(s) 1230) within a time available for responding to a request for an analysis and/o for a determination as to eligibility of a client account for a modification to the client account.

Before using the one or more ML models 1225 to identify the estimated receipt time(s) 1230 and/or the importance level(s) 1235, the ML engine 1120 performs initial training 1265 of the one or more ML models 1225 using training data 1270. The training data 1270 can include examples of input data identifying prior information (e.g., as in the prior data 1205) and/or examples of pre-determined estimated receipt time(s) and/or pre-determined importance level(s) (e.g., as in the pre-determined estimated receipt time(s) 1240 and/or the pre-determined importance level(s) 1245). In some examples, the pre-determined estimated receipt time(s) and/or the pre-determined importance level(s) in the training data 1270 are estimated receipt time(s) and/or importance level(s) that the one or more ML models 1225 previously identified based on the prior data in the training data 1270. In the initial training 1265, the ML engine 1120 can form connections and/or weights based on the training data 1270, for instance between nodes of a neural network or another form of neural network. For instance, in the initial training 1265, the ML engine 1120 can be trained to output the pre-determined estimated receipt time(s) and/or the pre-determined importance level(s) in the training data 1270 in response to receipt of the corresponding prior data in the training data 1270.

During a validation 1275 of the initial training 1265 (and/or further training 1255), the prior data 1205 (and/or the exemplary prior data in the training data 1270) is input into the one or more ML models 1225 to identify the estimated receipt time(s) 1230 and/or the importance level(s) 1235 as described above. The ML engine 1120 performs validation 1275 at least in part by determining whether the identified estimated receipt time(s) 1230 and/or the importance level(s) 1235 matches the pre-determined estimated receipt time(s) 1240 and/or the pre-determined importance level(s) 1245 (and/or the pre-determined estimated receipt time(s) and/or the pre-determined importance level(s) in the training data 1270). If the estimated receipt time(s) 1230 and/or the importance level(s) 1235 matches the pre-determined estimated receipt time(s) 1240 and/or the pre-determined importance level(s) 1245 during validation 1275, then the ML engine 1120 performs further training 1255 of the one or more ML models 1225 by updating the one or more ML models 1225 to reinforce weights and/or connections within the one or more ML models 1225 that contributed to the identification of the estimated receipt time(s) 1230 and/or the importance level(s) 1235, encouraging the one or more ML models 1225 to make determinations given similar inputs. If the estimated receipt time(s) 1230 and/or the importance level(s) 1235 does not match the pre-determined estimated receipt time(s) 1240 and/or the pre-determined importance level(s) 1245 during validation 1275, then the ML engine 1120 performs further training 1255 of the one or more ML models 1225 by updating the one or more ML models 1225 to weaken, remove, and/or replace weights and/or connections within the one or more ML models that contributed to the determination of the estimated receipt time(s) 1230 and/or the importance level(s) 1235, discouraging the one or more ML models 1225 from making similar determinations given similar inputs.

Validation 1275 and further training 1255 of the one or more ML models 1225 can continue once the one or more ML models 1225 are in use based on feedback 1250 received regarding the estimated receipt time(s) 1230 and/or the importance level(s) 1235. In some examples, the feedback 1250 can be received from a user via a user interface, for instance via an input from the user interface that approves or declines use of the estimated receipt time(s) 1230 and/or the importance level(s) 1235 for adjusting the account offer. In some examples, the feedback 1250 can be received from another component or subsystem, for instance based on whether the component or subsystem successfully uses the estimated receipt time(s) 1230 and/or the importance level(s) 1235, whether use the estimated receipt time(s) 1230 and/or the importance level(s) 1235 causes any problems for the component or subsystem, whether use the estimated receipt time(s) 1230 and/or the importance level(s) 1235 are accurate, or a combination thereof. If the feedback 1250 is positive (e.g., expresses, indicates, and/or suggests approval of the estimated receipt time(s) 1230 and/or the importance level(s) 1235, success of the estimated receipt time(s) 1230 and/or the importance level(s) 1235, and/or accuracy the estimated receipt time(s) 1230 and/or the importance level(s) 1235), then the ML engine 1120 performs further training 1255 of the one or more ML models 1225 by updating the one or more ML models 1225 to reinforce weights and/or connections within the one or more ML models 1225 that contributed to the identification of the estimated receipt time(s) 1230 and/or the importance level(s) 1235, encouraging the one or more ML models 1225 to make similar contractor quality score determinations given similar inputs. If the feedback 1250 is negative (e.g., expresses, indicates, and/or suggests disapproval of the estimated receipt time(s) 1230 and/or the importance level(s) 1235, failure of the estimated receipt time(s) 1230 and/or the importance level(s) 1235, and/or inaccuracy of the estimated receipt time(s) 1230 and/or the importance level(s) 1235) then the ML engine 1120 performs further training 1255 of the one or more ML models 1225 by updating the one or more ML models 1225 to weaken, remove, and/or replace weights and/or connections within the one or more ML models that contributed to the identification of the estimated receipt time(s) 1230 and/or the importance level(s) 1235, discouraging the one or more ML models 1225 to make similar contractor quality score determinations given similar inputs.

In some examples, the further training 1255 (and/or initial training 1265) can also use training data that includes analysis data 1280 with actual receipt times and/or importance levels corresponding to the estimated receipt time(s) 1230 and/or importance level(s) 1235. For instance, once the ML model(s) 1125 generate the analysis 1130, the ML engine 1120 can update the ML model(s) 1225 based on training data that includes for instance including actual times to receive the first and second datasets (in comparison to the estimated receipt time(s) 1230) and/or actual levels of importance of the first and second datasets to determining the confidence score (e.g., as measured based on an update amount between the preliminary confidence score and the confidence score) as compared to the estimated importance levels 1235.

FIG. 13 illustrates an exemplary computing system 1300 that may be used to implement some aspects of the technology. For example, any of the computing devices, computing systems, network devices, network systems, servers, and/or arrangements of circuitry described herein may include at least one computing system 1300, or may include at least one component of the computer system 1300 identified in FIG. 13. The computing system 1300 of FIG. 13 includes one or more processors 1310 and memory 1320. Each of the processor(s) 1310 may refer to one or more processors, controllers, microcontrollers, central processing units (CPUs), graphics processing units (GPUs), arithmetic logic units (ALUs), accelerated processing units (APUs), digital signal processors (DSPs), application specific integrated circuits (ASICs), field-programmable gate arrays (FPGAs), or combinations thereof. Each of the processor(s) 1310 may include one or more cores, either integrated onto a single chip or spread across multiple chips connected or coupled together. Memory 1320 stores, in part, instructions and data for execution by processor 1310. Memory 1320 can store the executable code when in operation. The computing system 1300 of FIG. 13 further includes a mass storage device 1330, portable storage device(s) 1340 (e.g., drive(s) and/or other storage media), output devices 1350, user input devices 1360, a display system 1370 (e.g., graphics display), and peripheral device(s) 1380.

The components shown in FIG. 13 are depicted as being connected via a single bus 1390. However, the components may be connected through one or more data transport means. For example, processor 1310 and memory 1320 may be connected via a local microprocessor bus, and the mass storage device 1330, peripheral device(s) 1380, portable storage device 1340, and display system 1370 may be connected via one or more input/output (I/O) buses.

Mass storage device 1330, which may be implemented with a magnetic disk drive or an optical disk drive, is a non-volatile storage device for storing data and instructions for use by processor 1310. Mass storage device 1330 can store the system software for implementing some aspects of the subject technology for purposes of loading that software into memory 1320.

Portable storage device 1340 operates in conjunction with a portable non-volatile storage medium, such as a floppy disk, compact disk or Digital video disc, to input and output data and code to and from the computer system 1300 of FIG. 13. The system software for implementing aspects of the subject technology may be stored on such a portable medium and input to the computer system 1300 via the portable storage device 1340.

The memory 1320, mass storage device 1330, or portable storage device 1340 may in some cases store sensitive information, such as transaction information, health information, or cryptographic keys, and may in some cases encrypt or decrypt such information with the aid of the processor 1310. The memory 1320, mass storage device 1330, or portable storage device 1340 may in some cases store, at least in part, instructions, executable code, or other data for execution or processing by the processor 1310.

Output devices 1350 may include, for example, communication circuitry for outputting data through wired or wireless means, display circuitry for displaying data via a display screen, audio circuitry for outputting audio via headphones or a speaker, printer circuitry for printing data via a printer, or some combination thereof. The display screen may be any type of display discussed with respect to the display system 1370. The printer may be inkjet, laserjet, thermal, or some combination thereof. In some cases, the output device 1350 (and/or associated circuitry) may allow for transmission of data over an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Output devices 1350 may include any ports, plugs, antennae, wired or wireless transmitters, wired or wireless transceivers, or any other components necessary for or usable to implement the communication types listed above, such as cellular Subscriber Identity Module (SIM) cards.

Input devices 1360 may include circuitry providing a portion of a user interface. Input devices 1360 may include an alpha-numeric keypad, such as a keyboard, for inputting alpha-numeric and other information, or a pointing device, such as a mouse, a trackball, stylus, or cursor direction keys. Input devices 1360 may include touch-sensitive surfaces as well, either integrated with a display as in a touchscreen, or separate from a display as in a trackpad. Touch-sensitive surfaces may in some cases detect localized variable pressure or force detection. In some cases, the input device circuitry may allow for receipt of data over an audio jack, a microphone jack, a universal serial bus (USB) port/plug, an Apple® Lightning® port/plug, an Ethernet port/plug, a fiber optic port/plug, a proprietary wired port/plug, a wired local area network (LAN) port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, personal area network (PAN) signal transfer, wide area network (WAN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Input devices 1360 may include any ports, plugs, antennae, wired or wireless receivers, wired or wireless transceivers, or any other components necessary for or usable to implement the communication types listed above, such as cellular SIM cards.

Input devices 1360 may include receivers or transceivers used for positioning of the computing system 1300 as well. These may include any of the wired or wireless signal receivers or transceivers. For example, a location of the computing system 1300 can be determined based on signal strength of signals as received at the computing system 1300 from three cellular network towers, a process known as cellular triangulation. Fewer than three cellular network towers can also be used-even one can be used-though the location determined from such data will be less precise (e.g., somewhere within a particular circle for one tower, somewhere along a line or within a relatively small area for two towers) than via triangulation. More than three cellular network towers can also be used, further enhancing the location's accuracy. Similar positioning operations can be performed using proximity beacons, which might use short-range wireless signals such as BLUETOOTH® wireless signals, BLUETOOTH® low energy (BLE) wireless signals, IBEACON® wireless signals, personal area network (PAN) signals, microwave signals, radio wave signals, or other signals discussed above. Similar positioning operations can be performed using wired local area networks (LAN) or wireless local area networks (WLAN) where locations are known of one or more network devices in communication with the computing system 1300 such as a router, modem, switch, hub, bridge, gateway, or repeater. These may also include Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. Input devices 1360 may include receivers or transceivers corresponding to one or more of these GNSS systems.

Display system 1370 may include a liquid crystal display (LCD), a plasma display, an organic light-emitting diode (OLED) display, a low-temperature poly-silicon (LTPO) display, an electronic ink or “e-paper” display, a projector-based display, a holographic display, or another suitable display device. Display system 1370 receives textual and graphical information, and processes the information for output to the display device. The display system 1370 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripheral device(s) 1380 may include any type of computer support device to add additional functionality to the computer system. For example, peripheral device(s) 1380 may include one or more additional output devices of any of the types discussed with respect to output device 1350, one or more additional input devices of any of the types discussed with respect to input device 1360, one or more additional display systems of any of the types discussed with respect to display system 1370, one or more memories or mass storage devices or portable storage devices of any of the types discussed with respect to memory 1320 or mass storage device 1330 or portable storage device 1340, a modem, a router, an antenna, a wired or wireless transceiver, a printer, a bar code scanner, a quick-response (“QR”) code scanner, a magnetic stripe card reader, an integrated circuit chip (ICC) card reader such as a smartcard reader or a EUROPAY®-MASTERCARD®-VISA® (EMV) chip card reader, a near field communication (NFC) reader, a document/image scanner, a visible light camera, a thermal/infrared camera, an ultraviolet-sensitive camera, a night vision camera, a light sensor, a phototransistor, a photoresistor, a thermometer, a thermistor, a battery, a power source, a proximity sensor, a laser rangefinder, a sonar transceiver, a radar transceiver, a lidar transceiver, a network device, a motor, an actuator, a pump, a conveyer belt, a robotic arm, a rotor, a drill, a chemical assay device, or some combination thereof.

The components contained in the computer system 1300 of FIG. 13 can include those typically found in computer systems that may be suitable for use with some aspects of the subject technology and represent a broad category of such computer components that are well known in the art. That said, the computer system 1300 of FIG. 13 can be customized and specialized for the purposes discussed herein and to carry out the various operations discussed herein, with specialized hardware components, specialized arrangements of hardware components, and/or specialized software. Thus, the computer system 1300 of FIG. 13 can be a personal computer, a hand held computing device, a telephone (“smartphone” or otherwise), a mobile computing device, a workstation, a server (on a server rack or otherwise), a minicomputer, a mainframe computer, a tablet computing device, a wearable device (such as a watch, a ring, a pair of glasses, or another type of jewelry or clothing or accessory), a video game console (portable or otherwise), an e-book reader, a media player device (portable or otherwise), a vehicle-based computer, another type of computing device, or some combination thereof. The computer system 1300 may in some cases be a virtual computer system executed by another computer system. The computer can also include different bus configurations, networked platforms, multi-processor platforms, etc. Various operating systems can be used including Unix®, Linux®, FreeBSD®, FreeNAS®, pfSense®, Windows®, Apple® Macintosh OS® (“MacOS®”), Palm OS®, Google® Android®, Google® Chrome OS®, Chromium® OS®, OPENSTEP®, XNUR, Darwin®, Apple IOS®, Apple® tvOS®, Apple® watchOS®, Apple® audioOS®, Amazon® Fire OS®, Amazon® Kindle OS®, variants of any of these, other suitable operating systems, or combinations thereof. The computer system 1300 may also use a Basic Input/Output System (BIOS) or Unified Extensible Firmware Interface (UEFI) as a layer upon which the operating system(s) are run.

In some cases, the computer system 1300 may be part of a multi-computer system that uses multiple computer systems 1300, each for one or more specific tasks or purposes. For example, the multi-computer system may include multiple computer systems 1300 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 1300 from different networks communicatively coupled together via the internet (also known as a “distributed” system).

Some aspects of the subject technology may be implemented in an application that may be operable using a variety of devices. Non-transitory computer-readable storage media refer to any medium or media that participate in providing instructions to a central processing unit (CPU) for execution and that may be used in the memory 1320, the mass storage device 1330, the portable storage device 1340, or some combination thereof. Such media can take many forms, including, but not limited to, non-volatile and volatile media such as optical or magnetic disks and dynamic memory, respectively. Some forms of non-transitory computer-readable media include, for example, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L7), resistive random-access memory (RRAM/ReRAM), phase change memory (PCM), spin transfer torque RAM (STT-RAM), another memory chip or cartridge, or a combination thereof.

Various forms of transmission media may be involved in carrying one or more sequences of one or more instructions to a processor 1310 for execution. A bus 1390 carries the data to system RAM or another memory 1320, from which a processor 1310 retrieves and executes the instructions. The instructions received by system RAM or another memory 1320 can optionally be stored on a fixed disk (mass storage device 1330/portable storage device 1340) either before or after execution by processor 1310. Various forms of storage may likewise be implemented as well as the necessary network interfaces and network topologies to implement the same.

While various flow diagrams and block diagrams provided and described above may show a particular order of operations performed by some embodiments of the subject technology, such as the block diagram 200 of FIG. 2, the flow diagram for process 300 of FIG. 3, the block diagram for the architecture 400 of FIG. 4, the block diagram 500 of FIG. 5, and the block diagram 600 of FIG. 6, it should be understood that such order is exemplary. Alternative embodiments may perform the operations in a different order, combine certain operations, overlap certain operations, or some combination thereof. It should be understood that unless disclosed otherwise, any process illustrated in any flow diagram herein or otherwise illustrated or described herein may be performed by a machine, mechanism, and/or computing system 1300 discussed herein, and may be performed automatically (e.g., in response to one or more triggers/conditions described herein), autonomously, semi-autonomously (e.g., based on received instructions), or a combination thereof. Furthermore, any action described herein as occurring in response to one or more particular triggers/conditions should be understood to optionally occur automatically response to the one or more particular triggers/conditions.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

Illustrative examples of the disclosure include:
Aspect 1: A method of dynamic time-dependent asynchronous analysis, the method comprising: transmitting a first query and a second query for information about a client associated with a client account; generating, using at least one trained machine learning model and based on prior data store interactions, respective estimated times to receive a first dataset responsive to a first query and a second dataset responsive to a second query; determining, using the at least one trained machine learning model and based on prior confidence score determinations, respective estimated importance levels of the first dataset and the second dataset to determining a confidence score for the client; generating a preliminary confidence score for the client based on the first dataset while waiting for the second dataset to be received; delaying temporarily until the second dataset is received to pause generation of the confidence score for the client based on the estimated importance level of the second dataset reaching at least an importance threshold and based on the estimated time to receive the second dataset being within an amount of time for responding to a request; updating the preliminary confidence score by an update amount using the second dataset to generate the confidence score for the client; determining an eligibility of the client account for a modification based on a comparison between the confidence score and a confidence threshold; and training the at least one trained machine learning model further using training data to update the at least one trained machine learning model for at least one further client analysis, wherein the training data includes the update amount and respective times to receive the first dataset and the second dataset.
Aspect 2. The method of Aspect 1, further comprising: determining, based on a time that a request is received, an amount of time for responding to the request with an eligibility of a client for a modification to a client account of the client based on the confidence score determined for the client.
Aspect 3. The method of any of Aspects 1 to 2, further comprising: transmitting an indication of the eligibility of the client account for the modification.
Aspect 4. The method of any of Aspects 1 to 3, wherein generating the preliminary confidence score for the client based on the first dataset includes generating the preliminary confidence score using the at least one trained machine learning model based on input of the first dataset into the at least one trained machine learning model.
Aspect 5. The method of any of Aspects 1 to 4, wherein updating the preliminary confidence score using the second dataset to generate the confidence score for the client includes generating the confidence score for the client using the at least one trained machine learning model based on input of the first dataset and the second dataset into the at least one trained machine learning model.
Aspect 6. The method of any of Aspects 1 to 5, wherein the training data also includes at least one of the preliminary confidence score or the confidence score for the client.
Aspect 7. The method of any of Aspects 1 to 6, wherein the training data also includes at least one of the respective estimated times to receive the first dataset and the second dataset or the respective estimated importance levels of the first dataset and the second dataset to determining the confidence score for the client.
Aspect 8. The method of any of Aspects 1 to 7, wherein transmitting the first query and the second query includes transmitting the first query in parallel with transmitting the second query.
Aspect 9. The method of any of Aspects 1 to 8, wherein transmitting the first query and the second query includes transmitting the first query and the second query serially.
Aspect 10. The method of any of Aspects 1 to 9, wherein the confidence score for the client corresponds to a worthiness of the client account for the modification, and wherein the modification to the client account includes at least one of a new account or a limit increase.
Aspect 11. The method of any of Aspects 1 to 10, further comprising: transmitting a third query; generating, using the at least one trained machine learning model and based on the prior data store interactions, an estimated time to receive a third dataset responsive to the third query; and determining, using the at least one trained machine learning model and based on the prior confidence score determinations, an estimated importance level of the third dataset to determining the confidence score for the client; wherein pausing temporarily until the second dataset is received includes pausing temporarily until the third dataset is also received to delay generation of the confidence score for the client based on the estimated importance level of the third dataset reaching at least the importance threshold and based on the estimated time to receive the second dataset being within the amount of time for responding to the request; and wherein updating the preliminary confidence score using the second dataset to generate the confidence score for the client includes updating the preliminary confidence score also using the third dataset to generate the confidence score for the client.
Aspect 12. The method of any of Aspects 1 to 11, further comprising: transmitting a third query; generating, using the at least one trained machine learning model and based on the prior data store interactions, an estimated time to receive a third dataset responsive to the third query; and determining not to wait to receive the third dataset to generate the confidence score for the client based on the estimated time to receive the third dataset failing to be within the amount of time for responding to the request.
Aspect 13. The method of any of Aspects 1 to 12, further comprising: transmitting a third query; determining, using the at least one trained machine learning model and based on the prior confidence score determinations, an estimated importance level of a third dataset to determining the confidence score for the client, wherein the third dataset is responsive to the third query; and determining not to wait to receive the third dataset to generate the confidence score for the client based on the estimated importance level of the third dataset failing to reach at least the importance threshold.
Aspect 14. The method of any of Aspects 1 to 13, further comprising: transmitting a third query; and updating the preliminary confidence score using a third dataset to generate an intermediate confidence score for the client, wherein the third dataset is responsive to the third query, wherein updating the preliminary confidence score using the second dataset to generate the confidence score includes updating the intermediate confidence score using the second dataset to generate the confidence score.
Aspect 15. The method of any of Aspects 1 to 14, further comprising: transmitting a third query; generating an updated confidence score for the client based on a third dataset after updating the preliminary confidence score for the client to generate the confidence score for the client, wherein the third dataset is responsive to the third query; identifying a change in the eligibility of the client account for the modification based on a comparison between the updated confidence score for the client and the confidence threshold; and transmitting an indication of the change in the eligibility of the client account for the modification.
Aspect 16. The method of any of Aspects 1 to 15, wherein the training data includes a second update amount indicative of a difference between the updated confidence score for the client and the confidence score for the client.
Aspect 17. The method of any of Aspects 1 to 16, wherein a score grading the client account is included in at least one of the first dataset or the second dataset.
Aspect 18. The method of any of Aspects 1 to 17, further comprising: receiving the first dataset and the second dataset from a data store, wherein the prior data store interactions identify at least one interaction with the data store.
Aspect 19. The method of any of Aspects 1 to 18, further comprising: receiving the first dataset from a first data store; and receiving the second dataset from a second data store, wherein the prior data store interactions identify at least a first interaction with the first data store and at least a second interaction with the second data store.
Aspect 20. The method of any of Aspects 1 to 19, further comprising: determining that the second dataset is receivable from a first data store and a second data store; determining that a second estimated time to receive the second dataset from the first data store is not within the amount of time for responding to the request; determining that the estimated time to receive the second dataset is within the amount of time for responding to the request, wherein the estimated time to receive the second dataset corresponds to receiving of the second dataset from the second data store; and receiving the second dataset from the second data store.
Aspect 21. The method of any of Aspects 1 to 20, further comprising: determining that the first dataset is receivable from a first data store and a second data store; determining that a second estimated time to receive the first dataset from the first data store is not within the amount of time for responding to the request; determining that the estimated time to receive the first dataset is within the amount of time for responding to the request, wherein the estimated time to receive the first dataset corresponds to receiving of the first dataset from the second data store; and receiving the first dataset from the second data store.
Aspect 22. The method of any of Aspects 1 to 21, wherein the confidence threshold is based on the prior confidence score determinations.
Aspect 23. A system for dynamic time-dependent asynchronous analysis, the system comprising: a memory; and a processor coupled to the memory, wherein the processor is configured to: transmit a first query and a second query for information about a client associated with a client account; generate, using at least one trained machine learning model and based on prior data store interactions, respective estimated times to receive a first dataset responsive to a first query and a second dataset responsive to a second query; determine, using the at least one trained machine learning model and based on prior confidence score determinations, respective estimated importance levels of the first dataset and the second dataset to determining a confidence score for the client; generate a preliminary confidence score for the client based on the first dataset while waiting for the second dataset to be received; delay temporarily until the second dataset is received to pause generation of the confidence score for the client based on the estimated importance level of the second dataset reaching at least an importance threshold and based on the estimated time to receive the second dataset being within an amount of time for responding to a request; update the preliminary confidence score by an update amount using the second dataset to generate the confidence score for the client; determine an eligibility of the client account for a modification based on a comparison between the confidence score and a confidence threshold; and train the at least one trained machine learning model further using training data to update the at least one trained machine learning model for at least one further client analysis, wherein the training data includes the update amount and respective times to receive the first dataset and the second dataset.
Aspect 24. The system of Aspect 23, further comprising: determining, based on a time that a request is received, an amount of time for responding to the request with an eligibility of a client for a modification to a client account of the client based on the confidence score determined for the client.
Aspect 25. The system of any of Aspects 23 to 24, further comprising: transmitting an indication of the eligibility of the client account for the modification.
Aspect 26. The system of any of Aspects 23 to 25, wherein generating the preliminary confidence score for the client based on the first dataset includes generating the preliminary confidence score using the at least one trained machine learning model based on input of the first dataset into the at least one trained machine learning model.
Aspect 27. The system of any of Aspects 23 to 26, wherein updating the preliminary confidence score using the second dataset to generate the confidence score for the client includes generating the confidence score for the client using the at least one trained machine learning model based on input of the first dataset and the second dataset into the at least one trained machine learning model.
Aspect 28. The system of any of Aspects 23 to 27, wherein the training data also includes at least one of the preliminary confidence score or the confidence score for the client.
Aspect 29. The system of any of Aspects 23 to 28, wherein the training data also includes at least one of the respective estimated times to receive the first dataset and the second dataset or the respective estimated importance levels of the first dataset and the second dataset to determining the confidence score for the client.
Aspect 30. The system of any of Aspects 23 to 29, wherein transmitting the first query and the second query includes transmitting the first query in parallel with transmitting the second query.
Aspect 31. The system of any of Aspects 23 to 30, wherein transmitting the first query and the second query includes transmitting the first query and the second query serially.
Aspect 32. The system of any of Aspects 23 to 31, wherein the confidence score for the client corresponds to a worthiness of the client account for the modification, and wherein the modification to the client account includes at least one of a new account or a limit increase.
Aspect 33. The system of any of Aspects 23 to 32, further comprising: transmitting a third query; generating, using the at least one trained machine learning model and based on the prior data store interactions, an estimated time to receive a third dataset responsive to the third query; and determining, using the at least one trained machine learning model and based on the prior confidence score determinations, an estimated importance level of the third dataset to determining the confidence score for the client; wherein pausing temporarily until the second dataset is received includes pausing temporarily until the third dataset is also received to delay generation of the confidence score for the client based on the estimated importance level of the third dataset reaching at least the importance threshold and based on the estimated time to receive the second dataset being within the amount of time for responding to the request; and wherein updating the preliminary confidence score using the second dataset to generate the confidence score for the client includes updating the preliminary confidence score also using the third dataset to generate the confidence score for the client.
Aspect 34. The system of any of Aspects 23 to 33, further comprising: transmitting a third query; generating, using the at least one trained machine learning model and based on the prior data store interactions, an estimated time to receive a third dataset responsive to the third query; and determining not to wait to receive the third dataset to generate the confidence score for the client based on the estimated time to receive the third dataset failing to be within the amount of time for responding to the request.
Aspect 35. The system of any of Aspects 23 to 34, further comprising: transmitting a third query; determining, using the at least one trained machine learning model and based on the prior confidence score determinations, an estimated importance level of a third dataset to determining the confidence score for the client, wherein the third dataset is responsive to the third query; and determining not to wait to receive the third dataset to generate the confidence score for the client based on the estimated importance level of the third dataset failing to reach at least the importance threshold.
Aspect 36. The system of any of Aspects 23 to 35, further comprising: transmitting a third query; and updating the preliminary confidence score using a third dataset to generate an intermediate confidence score for the client, wherein the third dataset is responsive to the third query, wherein updating the preliminary confidence score using the second dataset to generate the confidence score includes updating the intermediate confidence score using the second dataset to generate the confidence score.
Aspect 37. The system of any of Aspects 23 to 36, further comprising: transmitting a third query; generating an updated confidence score for the client based on a third dataset after updating the preliminary confidence score for the client to generate the confidence score for the client, wherein the third dataset is responsive to the third query; identifying a change in the eligibility of the client account for the modification based on a comparison between the updated confidence score for the client and the confidence threshold; and transmitting an indication of the change in the eligibility of the client account for the modification.
Aspect 38. The system of any of Aspects 23 to 37, wherein the training data includes a second update amount indicative of a difference between the updated confidence score for the client and the confidence score for the client.
Aspect 39. The system of any of Aspects 23 to 38, wherein a score grading the client account is included in at least one of the first dataset or the second dataset.
Aspect 40. The system of any of Aspects 23 to 39, further comprising: receiving the first dataset and the second dataset from a data store, wherein the prior data store interactions identify at least one interaction with the data store.
Aspect 41. The system of any of Aspects 23 to 40, further comprising: receiving the first dataset from a first data store; and receiving the second dataset from a second data store, wherein the prior data store interactions identify at least a first interaction with the first data store and at least a second interaction with the second data store.
Aspect 42. The system of any of Aspects 23 to 41, further comprising: determining that the second dataset is receivable from a first data store and a second data store; determining that a second estimated time to receive the second dataset from the first data store is not within the amount of time for responding to the request; determining that the estimated time to receive the second dataset is within the amount of time for responding to the request, wherein the estimated time to receive the second dataset corresponds to receiving of the second dataset from the second data store; and receiving the second dataset from the second data store.
Aspect 43. The system of any of Aspects 23 to 42, further comprising: determining that the first dataset is receivable from a first data store and a second data store; determining that a second estimated time to receive the first dataset from the first data store is not within the amount of time for responding to the request; determining that the estimated time to receive the first dataset is within the amount of time for responding to the request, wherein the estimated time to receive the first dataset corresponds to receiving of the first dataset from the second data store; and receiving the first dataset from the second data store.
Aspect 44. The system of any of Aspects 23 to 43, wherein the confidence threshold is based on the prior confidence score determinations.
Aspect 45. A non-transitory computer readable storage medium having embodied thereon a program, wherein the program is executable by a processor to perform a method of dynamic time-dependent asynchronous analysis, the method comprising: transmitting a first query and a second query for information about a client associated with a client account; generating, using at least one trained machine learning model and based on prior data store interactions, respective estimated times to receive a first dataset responsive to a first query and a second dataset responsive to a second query; determining, using the at least one trained machine learning model and based on prior confidence score determinations, respective estimated importance levels of the first dataset and the second dataset to determining a confidence score for the client; generating a preliminary confidence score for the client based on the first dataset while waiting for the second dataset to be received; delaying temporarily until the second dataset is received to pause generation of the confidence score for the client based on the estimated importance level of the second dataset reaching at least an importance threshold and based on the estimated time to receive the second dataset being within an amount of time for responding to a request; updating the preliminary confidence score by an update amount using the second dataset to generate the confidence score for the client; determining an eligibility of the client account for a modification based on a comparison between the confidence score and a confidence threshold; and training the at least one trained machine learning model further using training data to update the at least one trained machine learning model for at least one further client analysis, wherein the training data includes the update amount and respective times to receive the first dataset and the second dataset.
Aspect 46. The non-transitory computer readable storage medium of Aspect 45, further comprising: determining, based on a time that a request is received, an amount of time for responding to the request with an eligibility of a client for a modification to a client account of the client based on the confidence score determined for the client.
Aspect 47. The non-transitory computer readable storage medium of any of Aspects 45 to 46, further comprising: transmitting an indication of the eligibility of the client account for the modification.
Aspect 48. The non-transitory computer readable storage medium of any of Aspects 45 to 47, wherein generating the preliminary confidence score for the client based on the first dataset includes generating the preliminary confidence score using the at least one trained machine learning model based on input of the first dataset into the at least one trained machine learning model.
Aspect 49. The non-transitory computer readable storage medium of any of Aspects 45 to 48, wherein updating the preliminary confidence score using the second dataset to generate the confidence score for the client includes generating the confidence score for the client using the at least one trained machine learning model based on input of the first dataset and the second dataset into the at least one trained machine learning model.
Aspect 50. The non-transitory computer readable storage medium of any of Aspects 45 to 49, wherein the training data also includes at least one of the preliminary confidence score or the confidence score for the client.
Aspect 51. The non-transitory computer readable storage medium of any of Aspects 45 to 50, wherein the training data also includes at least one of the respective estimated times to receive the first dataset and the second dataset or the respective estimated importance levels of the first dataset and the second dataset to determining the confidence score for the client.
Aspect 52. The non-transitory computer readable storage medium of any of Aspects 45 to 51, wherein transmitting the first query and the second query includes transmitting the first query in parallel with transmitting the second query.
Aspect 53. The non-transitory computer readable storage medium of any of Aspects 45 to 52, wherein transmitting the first query and the second query includes transmitting the first query and the second query serially.
Aspect 54. The non-transitory computer readable storage medium of any of Aspects 45 to 53, wherein the confidence score for the client corresponds to a worthiness of the client account for the modification, and wherein the modification to the client account includes at least one of a new account or a limit increase.
Aspect 55. The non-transitory computer readable storage medium of any of Aspects 45 to 54, further comprising: transmitting a third query; generating, using the at least one trained machine learning model and based on the prior data store interactions, an estimated time to receive a third dataset responsive to the third query; and determining, using the at least one trained machine learning model and based on the prior confidence score determinations, an estimated importance level of the third dataset to determining the confidence score for the client; wherein pausing temporarily until the second dataset is received includes pausing temporarily until the third dataset is also received to delay generation of the confidence score for the client based on the estimated importance level of the third dataset reaching at least the importance threshold and based on the estimated time to receive the second dataset being within the amount of time for responding to the request; and wherein updating the preliminary confidence score using the second dataset to generate the confidence score for the client includes updating the preliminary confidence score also using the third dataset to generate the confidence score for the client.
Aspect 56. The non-transitory computer readable storage medium of any of Aspects 45 to 55, further comprising: transmitting a third query; generating, using the at least one trained machine learning model and based on the prior data store interactions, an estimated time to receive a third dataset responsive to the third query; and determining not to wait to receive the third dataset to generate the confidence score for the client based on the estimated time to receive the third dataset failing to be within the amount of time for responding to the request.
Aspect 57. The non-transitory computer readable storage medium of any of Aspects 45 to 56, further comprising: transmitting a third query; determining, using the at least one trained machine learning model and based on the prior confidence score determinations, an estimated importance level of a third dataset to determining the confidence score for the client, wherein the third dataset is responsive to the third query; and determining not to wait to receive the third dataset to generate the confidence score for the client based on the estimated importance level of the third dataset failing to reach at least the importance threshold.
Aspect 58. The non-transitory computer readable storage medium of any of Aspects 45 to 57, further comprising: transmitting a third query; and updating the preliminary confidence score using a third dataset to generate an intermediate confidence score for the client, wherein the third dataset is responsive to the third query, wherein updating the preliminary confidence score using the second dataset to generate the confidence score includes updating the intermediate confidence score using the second dataset to generate the confidence score.
Aspect 59. The non-transitory computer readable storage medium of any of Aspects 45 to 58, further comprising: transmitting a third query; generating an updated confidence score for the client based on a third dataset after updating the preliminary confidence score for the client to generate the confidence score for the client, wherein the third dataset is responsive to the third query; identifying a change in the eligibility of the client account for the modification based on a comparison between the updated confidence score for the client and the confidence threshold; and transmitting an indication of the change in the eligibility of the client account for the modification.
Aspect 60. The non-transitory computer readable storage medium of any of Aspects 45 to 59, wherein the training data includes a second update amount indicative of a difference between the updated confidence score for the client and the confidence score for the client.
Aspect 61. The non-transitory computer readable storage medium of any of Aspects 45 to 60, wherein a score grading the client account is included in at least one of the first dataset or the second dataset.
Aspect 62. The non-transitory computer readable storage medium of any of Aspects 45 to 61, further comprising: receiving the first dataset and the second dataset from a data store, wherein the prior data store interactions identify at least one interaction with the data store.
Aspect 63. The non-transitory computer readable storage medium of any of Aspects 45 to 62, further comprising: receiving the first dataset from a first data store; and receiving the second dataset from a second data store, wherein the prior data store interactions identify at least a first interaction with the first data store and at least a second interaction with the second data store.
Aspect 64. The non-transitory computer readable storage medium of any of Aspects 45 to 63, further comprising: determining that the second dataset is receivable from a first data store and a second data store; determining that a second estimated time to receive the second dataset from the first data store is not within the amount of time for responding to the request; determining that the estimated time to receive the second dataset is within the amount of time for responding to the request, wherein the estimated time to receive the second dataset corresponds to receiving of the second dataset from the second data store; and receiving the second dataset from the second data store.
Aspect 65. The non-transitory computer readable storage medium of any of Aspects 45 to 64, further comprising: determining that the first dataset is receivable from a first data store and a second data store; determining that a second estimated time to receive the first dataset from the first data store is not within the amount of time for responding to the request; determining that the estimated time to receive the first dataset is within the amount of time for responding to the request, wherein the estimated time to receive the first dataset corresponds to receiving of the first dataset from the second data store; and receiving the first dataset from the second data store.
Aspect 66. The non-transitory computer readable storage medium of any of Aspects 45 to 65, wherein the confidence threshold is based on the prior confidence score determinations.

What is claimed is:

1. A method of choreographing requests for and receipt of data from various services, the method comprising:
receiving rule data, wherein the rule data corresponds to a set of rules, and wherein the set of rules continues to be updated over time;
receiving request data, wherein the request data identifies information to be requested from a plurality of information sources on behalf of one or more services;
modifying the request data, based on the rule data, to select a subset of a plurality of information sources to request the information from;
generating one or more requests for the information;
sending each of the one or more requests to a respective information source of the subset;
aggregating the information as received from the subset to generate aggregated information;
sending the aggregated information to the one or more services; and
initiating one or more analyses by the one or more services using the aggregated information.

2. The method of claim 1, wherein the rule data identifies a backup information source corresponding to a preferred information source of the plurality of information sources, wherein the one of the preferred information source or the backup information source is selected for the subset based on a timeliness of the preferred information source and a synchronization status of the backup information source.

3. The method of claim 1, wherein the rule data is used to select the subset of the plurality of information sources based on respective conditions associated the plurality of information sources.

4. The method of claim 1, wherein the rule data is used to select the subset of the plurality of information sources based on respective quality scores associated the plurality of information sources.

5. The method of claim 1, wherein the rule data includes at least a portion of the set of rules.

6. The method of claim 1, wherein the rule data includes an update to at least one rule of the set of rules.

7. The method of claim 1, wherein sending each of the one or more requests to the respective information source of the subset includes sending a first request and a second request in parallel, wherein the first request is to a first information source of the subset, and wherein the second request is to a second information source of the subset.

8. The method of claim 1, further comprising:
receiving the information from the subset.

9. The method of claim 1, wherein the information as received from the subset is missing a portion of the information to be requested as indicated in the request data.

10. The method of claim 9, further comprising:
sending a secondary request to a secondary information source for the portion of the information; and
receiving the portion of the information from the secondary information source, wherein the aggregated information includes the portion of the information as received from the secondary information source.

11. The method of claim 1, further comprising:
initiating a timer to count for a predetermined amount of time after sending each of the one or more requests;
waiting for the information to be received from the subset while the timer counts for the predetermined amount of time and until the timer reaches the predetermined amount of time; and
in response to the timer reaching the predetermined amount of time without receipt of a portion of the information from the subset, generating the aggregated information without the portion of the information.

12. The method of claim 1, initiating a timer to count for a predetermined amount of time after sending each of the one or more requests;
waiting for the information to be received from the subset while the timer counts for the predetermined amount of time; and
receiving the information from the subset before the timer reaches the predetermined amount of time.

13. The method of claim 1, where the one or more analyses evaluate eligibility of a user for a program.

14. The method of claim 13, further comprising:
onboarding the user onto the program based on the one or more analyses.

15. An apparatus for choreographing requests for and receipt of data from various services, the apparatus comprising:
a communication interface coupled to a network;
a memory that stores instructions; and
a processor that executes the instructions, wherein execution of the instructions by the processor causes the processor to:
receive rule data, wherein the rule data corresponds to a set of rules, and wherein the set of rules continues to be updated over time;
receive request data, wherein the request data identifies information to be requested from a plurality of information sources on behalf of one or more services;
modify the request data, based on the rule data, to select a subset of a plurality of information sources to request the information from;
generate one or more requests for the information;
send each of the one or more requests to a respective information source of the subset;
aggregate the information as received from the subset to generate aggregated information;
send the aggregated information to the one or more services; and
initiate one or more analyses by the one or more services using the aggregated information.

16. The apparatus of claim 15, wherein the rule data identifies a backup information source corresponding to a preferred information source of the plurality of information sources, wherein the one of the preferred information source or the backup information source is selected for the subset based on a timeliness of the preferred information source and a synchronization status of the backup information source.

17. The apparatus of claim 15, wherein the rule data is used to select the subset of the plurality of information sources based on respective conditions associated the plurality of information sources.

18. The apparatus of claim 15, wherein the rule data is used to select the subset of the plurality of information sources based on respective quality scores associated the plurality of information sources.

19. The apparatus of claim 15, wherein the rule data includes at least a portion of the set of rules.

20. The apparatus of claim 15, wherein the rule data includes an update to at least one rule of the set of rules.

21. The apparatus of claim 15, wherein sending each of the one or more requests to the respective information source of the subset includes sending a first request and a second request in parallel, wherein the first request is to a first information source of the subset, and wherein the second request is to a second information source of the subset.

22. The apparatus of claim 15, further comprising:
receiving the information from the subset.

23. The apparatus of claim 15, wherein the information as received from the subset is missing a portion of the information to be requested as indicated in the request data.

24. The apparatus of claim 23, further comprising:
sending a secondary request to a secondary information source for the portion of the information; and
receiving the portion of the information from the secondary information source, wherein the aggregated information includes the portion of the information as received from the secondary information source.

25. The apparatus of claim 15, further comprising:
initiating a timer to count for a predetermined amount of time after sending each of the one or more requests;
waiting for the information to be received from the subset while the timer counts for the predetermined amount of time and until the timer reaches the predetermined amount of time; and
in response to the timer reaching the predetermined amount of time without receipt of a portion of the information from the subset, generating the aggregated information without the portion of the information.

26. The apparatus of claim 15, initiating a timer to count for a predetermined amount of time after sending each of the one or more requests;
waiting for the information to be received from the subset while the timer counts for the predetermined amount of time; and
receiving the information from the subset before the timer reaches the predetermined amount of time.

27. The apparatus of claim 15, where the one or more analyses evaluate eligibility of a user for a program.

28. The apparatus of claim 27, further comprising:
onboarding the user onto the program based on the one or more analyses.

29. A non-transitory computer readable storage medium having embodied thereon a program, wherein the program is executable by a processor to perform a method of choreographing requests for and receipt of data from various services, the method comprising:
receiving, from a service, a request for a dataset;
requesting the dataset from a primary data source and a secondary data source;
initiating a timer to count for a predetermined amount of time after requesting the dataset;
waiting for the dataset to be received from the primary data source while the timer counts for the predetermined amount of time and until the timer reaches the predetermined amount of time;
in response to the timer reaching the predetermined amount of time without receipt of the dataset from the primary data source, automatically providing the dataset as received from the secondary data source to the service; and
initiating an analysis by the service using the dataset.

30. The non-transitory computer readable storage med of claim 29, wherein the rule data identifies a backup information source corresponding to a preferred information source of the plurality of information sources, wherein the one of the preferred information source or the backup information source is selected for the subset based on a timeliness of the preferred information source and a synchronization status of the backup information source.
